(19) United States
(12) Patent Application Publication
(10) Pub. No.: US 2026/0230919 A1
(43) Pub. Date: Aug. 6, 2026

(54) METHODS FOR USER PLANE AND DATA PLANE ARCHITECTURES

(71) Applicant: InterDigital Patent Holdings, Inc., Wilmington, DE (US)

(72) Inventors: Faris Alfarhan, Montreal (CA); Samuli Turtinen, Li (FI); Oumer Teyeb, Montreal (CA); Tuong Hoang, Montreal (CA); Pascal Adjakple, Great Neck, NY (US); Diana Pani, Montreal (CA); Ghyslain Pelletier, Montreal (CA); Francois Periard, Montreal (CA); Keiichi Kubota, Setagaya-Ku (JP); Martino Freda, Laval (CA); Brian Martin, Farnham (GB); James Miller, Northport, NY (US)

(73) Assignee: InterDigital Patent Holdings, Inc., Wilmington, DE (US)

(21) Appl. No.: 19/046,453

(22) Filed: Feb. 5, 2025

(51) Int. Cl. H04W 28/02; H04W 28/06

(52) U.S. Cl. CPC H04W 28/0278; H04W 28/06

(57) ABSTRACT

A wireless transmit/receive unit (WTRU) comprise a processor configured to receive configuration information from a network, wherein the configuration information indicates that the WTRU is configured to process data of a first data type and data of a second data type, wherein the data of the first data type comprises user plane data, and wherein the configuration information further comprises one or more parameters for buffer management for the second data type and a threshold to send a buffer status report associated with the data of the second data type. The processor may store the data of the first data type in a first buffer, store the data of the second data type in a second buffer, and send the buffer status report and at least a portion of the data of the second data type.

### BACKGROUND

The current user plane interface, originally developed in 3G and 4G, was designed to meet best effort data with a minimum and guaranteed bit rate requirements. A new layer 2 (L2) data plane interface may consider the following requirements.

### SUMMARY

A wireless transmit/receive unit (WTRU) may comprise a processor. The processor may be configured to receive configuration information from a network, wherein the configuration information indicates that the WTRU is configured to process data of a first data type and data of a second data type, wherein the data of the first data type comprises user plane data, and wherein the configuration information further comprises one or more parameters for buffer management for the second data type and a threshold to send a buffer status report associated with the data of the second data type. The processor may be configured to store the data of the first data type in a first buffer. The processor may be configured to store the data of the second data type in a second buffer based on the one or more parameters for buffer management for the second data type. Based on a comparison between the threshold and the data of the second data type stored in the second buffer or the data of the first data type stored in the first buffer, the processor may be configured to send the buffer status report and send at least a portion of the data of the second data type.

The processor may be configured to send the buffer status report based on the data of the second data type stored in the second buffer being greater than the threshold. Data plane volume may include, for example, the whole data plane (e.g., there may be several data collection bearers under the data plane). Data plane volume may include, for example, one bearer on the data plane.

The processor may be configured to send the buffer status report based on the data of the first data type stored in the first buffer being less than the threshold. The processor may be configured to send the buffer status report based on a priority of the data of the first data type stored in the first buffer being less than the threshold. The processor may be configured to send the buffer status report based on reception of a request from the network. The data of the second data type may include, for example, artificial intelligence or machine learning (AI/ML) data or data relating to a sensing operation.

The processor may be configured to receive a request from the network to generate the data of the second data type. The processor may be configured to generate the data of the second data type in response to the request.

The processor may be configured to receive the data of the second data type. The processor may be configured to store the data of the second data type in response to the reception of the data of the second data type.

The processor may be configured to start a timer associated with the data of the second data type. Upon an expiration of the timer, the processor may be configured to perform one or more of the following: discard a service data unit (SDU) associated with the data of the second data type; discard at least a portion of the data of the second data type; or send at least at portion of the data of the second data type.

The processor may be configured to increment a stored data volume associated with the data of the second data type based on an amount of the data. The processor may be configured to receive an indication from the network via downlink control information (DCI) to transmit at least a portion of the data of the second data type.

A wireless transmit/receive unit (WTRU) may comprise a processor. The processor may be configured to receive configuration information from a network, wherein the configuration information indicates that the WTRU is configured to process data of a first data type and data of a second data type, wherein the data of the first data type comprises user plane data, and wherein the configuration information further comprises one or more parameters for buffer management for the second data type and an indication of a trigger to send a buffer status report associated with the data of the second data type. The processor may be configured to store the data of the first data type in a first buffer. The processor may be configured to store the data of the second data type in a second buffer based on the one or more parameters for buffer management for the second data type. The processor may be configured to start a timer associated with storage of the data of the second data type. Based on the trigger, the processor may be configured to send the buffer status report and send at least a portion of the data of the second data type.

The trigger may include, for example, buffered user plane data is of priority is less than a threshold. The trigger may include, for example, buffered user plane data volume is less than a threshold. The trigger may include, for example, DL signaling is received from the network polling/requesting for a DP BSR. The trigger may include, for example, the storage period timer has expired or the remaining time before expiry is less than a threshold. The trigger may include, for example, the amount stored data volume is larger than a threshold (e.g. max stored data volume). The trigger may include, for example, load/NW congestion conditions. The trigger may include, for example, determined NES state. The trigger may include, for example, the WTRU power saving state. The trigger may include, for example, the WTRU CPU load or processing state. The trigger may include, for example, time of the day condition. The trigger may include, for example, a data collection reporting request from application layer (e.g., if the collected data is to be sent to an application server outside the operator's network). The trigger may include, for example, a measured channel condition being larger or lower than a configured threshold.

A WTRU may be configured to perform a method that includes one or more of the following steps. The method may include receiving configuration information from a network, wherein the configuration information indicates that the WTRU is configured to process data of a first data type and data of a second data type, wherein the data of the first data type comprises user plane data, and wherein the configuration information further comprises one or more parameters for buffer management for the second data type and a threshold to send a buffer status report associated with the data of the second data type. The method may include storing the data of the first data type in a first buffer. The method may include storing the data of the second data type in a second buffer based on the one or more parameters for buffer management for the second data type. Based on a comparison between the threshold and the data of the second data type stored in the second buffer or the data of the first data type stored in the first buffer, the method may include sending the buffer status report and sending at least a portion of the data of the second data type.

The method may include sending the buffer status report based on the data of the second data type stored in the second buffer being greater than the threshold. The method may include sending the buffer status report based on the data of the first data type stored in the first buffer being less than the threshold. The method may include sending the buffer status report based on a priority of the data of the first data type stored in the first buffer being less than the threshold. The method may include sending the buffer status report based on reception of a request from the network. The data of the second data type may include, for example, artificial intelligence or machine learning (AI/ML) data or data relating to a sensing operation.

The method may include receiving a request from the network to generate the data of the second data type. The method may include generating the data of the second data type in response to the request.

The method may include receiving the data of the second data type. The method may include storing the data of the second data type in response to the reception of the data of the second data type.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a system diagram illustrating an example of Buffer/Queue management with logical queues for co-existence between delay-critical and non-delay critical traffics according to an embodiment.

FIG. 3 is a system diagram illustrating an example WTRU assisted low latency low loss scalable throughput (L4S) explicit congestion notification (ECN) marking at base according to an embodiment.

FIG. 4 is a system diagram illustrating an example many to many mapping of MAC and HARQ entity, RU, carrier, and/or BWP according to an embodiment.

FIG. 5 is a system diagram illustrating an example PDCP entity being mapped to more than one RLC entity, and a given RLC entity being mapped to many PDCP entities according to an embodiment.

FIG. 6 is a system diagram illustrating an example PDCP to RLC entity mapping (non-DRB based) according to an embodiment.

FIG. 7 is a system diagram illustrating an example where the PDCP handles data flows and/or QoS flows and MAC schedules per data flow, from the transmission side, for instance, uplink at WTRU or downlink at NW node (e.g., 6G-NB) according to an embodiment.

FIG. 8 is a system diagram illustrating an example where the PDCP handles data flows and/or QoS flows and MAC schedules per data flow, from the receiver side, for instance, downlink at WTRU or uplink at NW node (e.g., 6G-NB) according to an embodiment.

FIG. 9 is a system diagram illustrating an example where the PDCP handles data flows and/or QoS flows and MAC schedules per logical channel, from the transmission side, for instance, uplink at the WTRU or downlink at NW node (e.g., 6G-NB) according to an embodiment.

FIG. 10 is a system diagram illustrating an example where the PDCP handles data flows and/or QoS flows and MAC schedules per logical flow, from the receiver side, for instance, downlink at WTRU or uplink at NW node (e.g., 6G-NB) according to an embodiment.

FIG. 11 is a system diagram illustrating an example data plane protocol stack model according to an embodiment.

### DETAILED DESCRIPTION

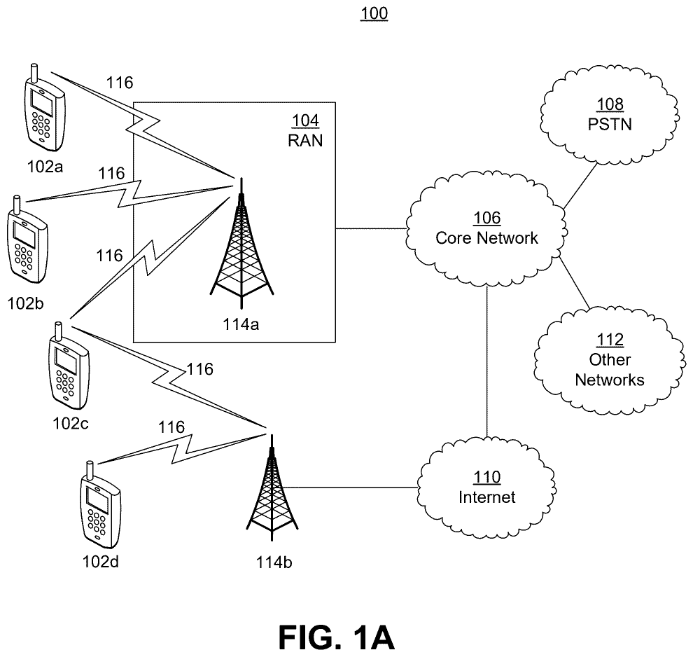

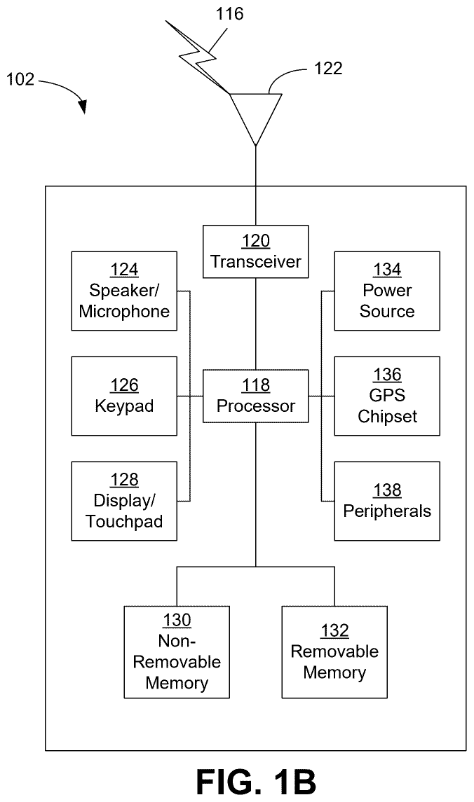

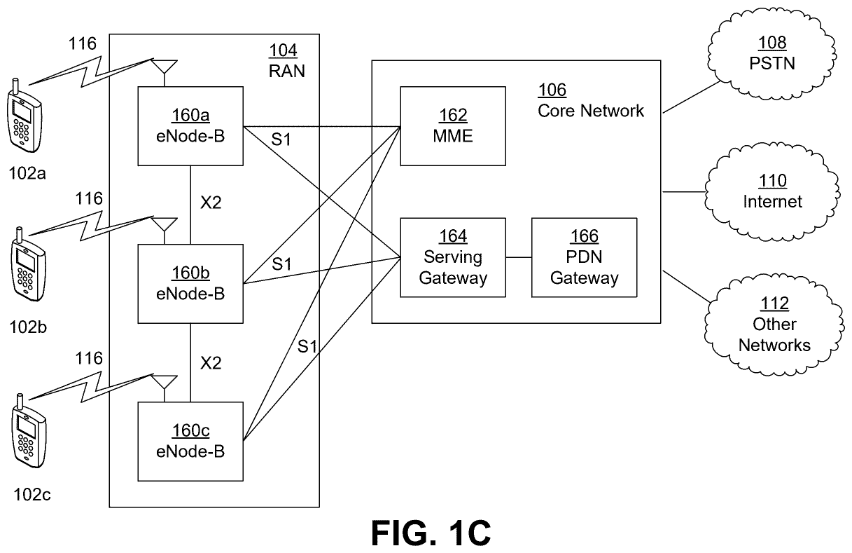

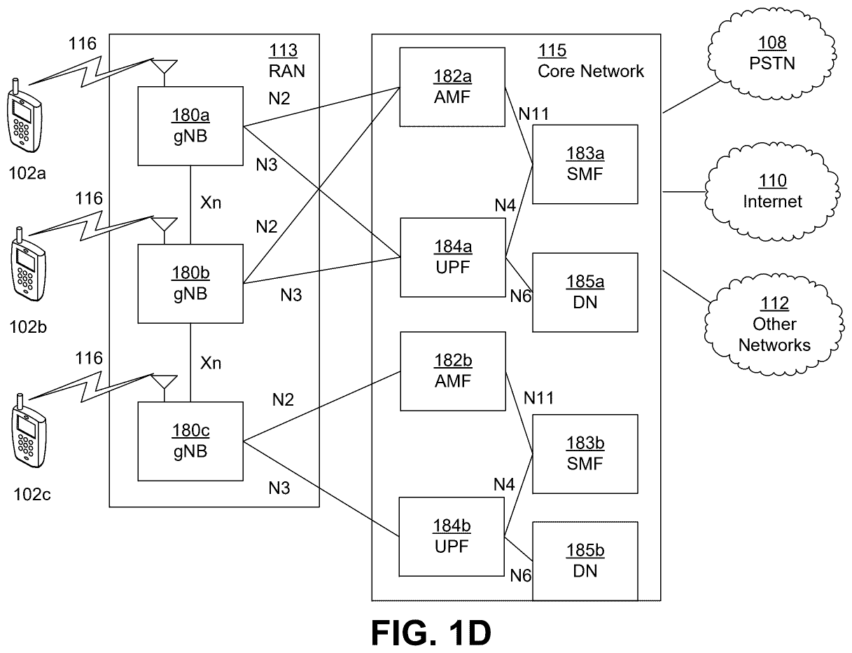

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A new L2 data plane interface may consider computational efficiency. For instance, L2 processing scales linearly with packet rate: as the packet rate increases, it may significantly boost processing demands and power consumption, creating overhead challenges for both the network and the wireless transmit/receive unit (WTRU). Layering of L2 protocols may create an overly hierarchical structure leading to manufactured latencies and increased computational complexity.

For example, a new L2 data plane interface may consider quality of service (QoS), latency and reliability. For instance, L2 interface may provide support for variable QoS requirements, low latency, and high reliability, including extreme applications, including extended reality (XR), virtual reality (VR), augmented reality (AR), highly-reliable and low latency communications (HRLLC), and enhanced ultra-reliable and low latency communications (eURLLC). Retransmissions currently are duplicated in multiple layers. Retransmissions at higher layers (e.g. radio link control (RLC)) are too slow to meet latency sensitive applications (e.g. XR). Retransmissions are also quite rigid (e.g., retransmission data is exactly the same, same transport block (TB) size, same carrier etc.). QoS attributes may be assigned to each data set and/or channel, including the usual key performance indicators (KPIs): Priority, policy-based routing (PBR), packet delay budgeting (PDB), packet error rate (PER), block error rate (BLER), and/or additional KPIs: PDU set delay budget (PSDB), dependencies to other sets, strict delay, energy consumption, and/or complexity metrics. An L2 interface should enable elastic quality of experience (QoE) level varying (e.g. somewhere between the minimum data rate and/or guaranteed bit rate (GBR) and maximum data rate), though QoS is met. QoE must meet a minimum requirement. For example, the WTRU may start transmission of data with a given QoE level that is higher, then as the WTRU moves out of coverage, experiences cell congestion, and/or when data rate drops, the WTRU may then reduce the QoE level and/or reduce the number of data packet sets that are transmitted (e.g. if there are multiple and/or multi-modal streams, the WTRU may drop one stream that is not necessary to meet the minimum QoE level while still maintaining the QoS).

For example, a new L2 data plane interface may consider support of different data types. For instance, currently signaling radio bearer (SRB) and data radio bearer (DRB) data are differentiated, and treatment of user plane (UP) data QoS is controlled by QoS flow to DRB mapping. Once mapped to a DRB, packet treatment is done semi-statically. New applications (e.g. artificial intelligence or machine learning (AI/ML), XR, sensing, volumetric video) introduce new data types, potentially within a QoS flow. New Radio (NR) UP does not provide differentiated treatment for more important and/or systematic packets (e.g. for a QoS flow). Data sets can be classified by type (e.g. control, data, sensory, AI/ML data). The L2 interface may therefore support means to avoid unnecessary data transmission, and handling of QoS/QoE dependencies between different data types (UP, control plane (CP), system data) and dependencies between data of the same type.

For example, a new L2 data plane interface may consider WTRU and network (NW) power consumption. For instance, the L2 protocol should enable both WTRU and NW power savings. DRBs are not elastic in terms of resource allocation and mapping across cells and cell groups. The L2 interface may therefore support means for timely WTRU reachability, WTRU processing chain power consumption, balancing NW & WTRU energy consumption. A packet data unit (PDU) should be able to transmitted and/or received in a more dynamic manner, where without rigid restrictions on DRB, carrier, and/or cell group.

For example, a new L2 data plane interface may consider scheduling, capacity and congestion. For instance, configured grants are responsive to delay bounds but consumes heavy overhead. Transmission on dynamic grants following scheduling request (SR)/buffer status report (BSR) may incur delays. Logical channel prioritization (LCP) is based on leaky bucket uplink traffic shaping, and may not consider inter-packet associations, latency bounds, and/or congestion.

For example, a new L2 data plane interface may consider application layer awareness. For instance, NR UP may not provide differentiated treatment for more important packets (e.g., relevance may vary over time and/or over other control reception, for example, within a bearer). Several applications generate packets that have different importance. L2 protocols have not evolved with new application layer transport protocols (e.g. Quick user datagram protocol (UDP) Internet Connections (QUIC) developed for faster, more reliable, and more efficient data transfer). Awareness includes radio access network (RAN) aware of application QoS and QoE metrics and/or data (e.g., events, important and/or relevant data) and the application being aware of RAN dynamic conditions (e.g. radio conditions, congestion, cell load, etc.). The application itself may adjust the rate of the packet set, and in such case the WTRU may not change the underlying QoE level (e.g. when the video rate is decreased by the application). This may mean that the WTRU may or may not be aware of the application layer's processes (e.g., no awareness in the first case, but awareness in the second way). Awareness also involves awareness of application flow dependencies and/or synchronization and other system data (e.g. sensory, ML, CP triggered events like handover, etc.).

In uplink transmission, a traffic scheduling regulator “S” may be used to characterize traffic transmission rates at the WTRU. “S” may determine the worst-case bounds on delay and backlog in the WTRU's buffer, where a traffic arrival function “A” may describe the cumulative arrival function of traffic for a given flow to the WTRU's buffer and “D” describes the transmission departure function from the WTRU's buffer to a scheduled grant. Each traffic flow competing for resources on a given uplink grant can be shaped by an envelope “E” such that E(t−s)>=A(s,t). A traffic shaper is a scheduling implementation which enforces that departing uplink (UL) traffic complies to a given traffic envelope and which buffers non-compliant traffic.

Reasons for shaping traffic for a given flow may include, for example, an operator may want to enforce that traffic from and to a given data flow complies to the subscribed data rate. Reasons for shaping traffic for a given flow may include video streaming over a cellular network may require matching the rate of video streams to the available capacity of the RF link. This kind of regulation is referred to as traffic shaping or smoothing. Transmitted traffic may be classified as shaped and/or compliant traffic, for example, traffic that satisfies a given traffic specification (e.g. traffic served in with the bounds of the traffic departure envelope). Transmitted traffic may be classified as non-shaped traffic, for example, traffic allocated to a grant and exceeding the traffic shaper (e.g. the water level in traffic shaping bucket). Such traffic may be considered lower or best-effort priority and is buffered if not transmitted.

An example of a traffic shaping regulator for a given flow is the leaky bucket algorithm, whereby the bucket is filled with fluid up to the indicated level, where LB(t) indicates the filling level of the bucket at time t. Initially, the bucket is set to LB(0)=b, which is referred to as a full bucket. The buffer is filled with fluid at a rate r, however, nothing is added when the bucket is full. The content of the bucket LB(t) corresponds to the maximum amount of traffic that can be transmitted at the time of TB construction (e.g., assuming sufficient space). For each transmission of a service data unit (SDU), the content of the leaky bucket may be reduced by the size of the SDU. When LB(t)=0, the bucket is empty, and no traffic can be transmitted. Traffic arrivals to an empty bucket are stored in the buffer and traffic in the buffer is transmitted at the filling rate r.

The LCP algorithm used for UL TB construction in LTE and NR is an example of a leaky bucket implementation. The LCP “Bj” is essentially a leaky bucket that enforces that traffic complies to a long-term rate (PBR) and a bucket size (PBR ×buffer size duration (BSD)).

In one example data plane architecture framework, an application may provide one or more IP flows for transmission over a medium. Each IP flow may go through a transport layer protocol (e.g. transmission control protocol/internet protocol (TCP/IP), QUIC, real-time transport protocol (RTP), media over QUIC (MoQ), etc.). Each IP flow (e.g. a PDU session) may go through a RAN core network, which may map it to a RAN data flow and/or a RAN data set. For each RAN data flow, the core network may attach some QoS requirements, a QoS metric, a range of QoE metrics, etc.

Discussed herein, a RAN data flow may represent a logical association between data packets and/or units (e.g. originating from the same IP flow). Such association may be based on such data units being associated to the same IP flow, application flow, and/or having the same association packet marked either by the core network or the application.

Some RAN data flows may not originate from a user application, but rather from the control plane (e.g. control data and RAN signaling and configurations), an intelligence plane (e.g. data collected from AI/ML services), a computing plan (e.g. used for native computing for computing services), a system plane (i.e. data originating within the RAN, e.g. due to sensing or positioning services), and/or a security plane.

The WTRU may assign a QoS class to each data unit within a RAN data flow for the purpose of characterization of how data should be transmitted. A data protocol plane may contain a data unit classification function for QoS and/or QoE marking throughout the protocol chain. The QoS and/or QoE class may be determined in such layer according to one or more configured and/or predefined rule. Such QoS class may be used in various layers within the data plan protocol chain for achieving a certain QoS requirement and/or a QoE level. A QoS class may indicate part of a protocol layer header. Each QoS and/or QoE class may be associated with a QoS and/or QoE treatment profile in the RAN, which may be configured semi-statically. Each QoS treatment profile may contain a number of parameters to control the RAN treatment of the data transmission and/or reception and a number of metrics to achieve the QoE level for a given layer in the protocol chain. Each QoS class and/or QoS treatment profile may be associated and/or configured with: a priority index, an importance level, a delay bound, a reliability level, a guaranteed bit rate, a maximum bit rate, and/or a maximum packet loss rate.

The WTRU may use a procedure to classify UL data units (e.g. packets within a data flow, SDUs, and/or PDUs within a PDU set) on a dynamic basis, where a data unit can be assigned with a QoS Class if it meets one or more conditions.

Once a condition for QoS classification is met, the WTRU may assign a certain QoS class value to a given data unit, which may or may not be the default QoS class. The WTRU may be configured with a default QoS class, which may be preconfigured semi-statically for the whole data flow. If no special classification conditions are met, the WTRU classifies a data unit from such flow with the configured default QoS class for the data flow. The WTRU may be configured or predefined with one or more non-default QoS class(es), where there is a mapping between a given QoS class and/or a condition for QoS classification. Once met, the WTRU associates the data unit with the non-default QoS class.

A condition for QoS classification may include one or more of the following. For example, a condition for QoS classification may include packet priority. For instance, based on the possibility of transmission and/or inclusion of buffered data from a subset of PDUs within a PDU set, where such PDUs may be configured or predetermined to be of higher priority, a lower delay bound, or high QoS treatment profile compared to other PDUs within the set. If the data unit is of higher priority, the WTRU may associate data unit with a given QoS class. If the data unit is of lower priority, the WTRU may associate data unit with another QoS class.

For example, a condition for QoS classification may include packet importance. For instance, based on the possibility of transmission and/or inclusion of buffered data from a subset of PDUs within a PDU set, where such PDUs can be configured or predetermined to be of higher importance compared to other PDUs within the set, where importance is a value obtained from an indication from the core network packet profile, the application interface, or from the service characteristics (e.g. the period of the packet or the type of packet associated with it). If the data unit is of higher importance, the WTRU may associate data unit with a given QoS class. If the data unit is of lower importance, the WTRU may associate data unit with another QoS class.

For example, a condition for QoS classification may include packet delay budget. For instance, possibility of transmission and/or inclusion of buffered data from a subset of PDUs within a PDU set, where the remaining time until the delay budget for the PDU and/or the underlying application is less than a threshold. If the delay budget is less than a threshold, the WTRU may associate data unit with a given QoS class.

For example, a condition for QoS classification may include the data type. For instance, a condition can be met as a function of inclusion of data from a given type (e.g. AI/ML, XR, sensing, and/or volumetric video). For example, for a data unit containing AL/ML data, the WTRU may associate data unit with a given QoS class. For a data unit containing sensing data, the WTRU may associate data unit with another QoS class.

For example, a condition for QoS classification may include reception of an indication from the application and/or the RAN-application interface (e.g., application programming interface (API)). For instance, the application may indicate that for a given data unit, a differentiated QoS class is to be associated. The indication may provide a given QoS class and/or an identifier associated with it. The WTRU may be configured with a given non-default QoS class to apply to a data unit once an indication and/or flag is received from the API for such data unit. For example, upon reception of an indication from higher layers (e.g. from application) indicating that such a packet needs to be prioritized ahead of other buffered packets in the queue for such data flow, the WTRU may associate a different (e.g. non default) QoS class to the data unit.

For example, a condition for QoS classification may include reception of an indication from the network overriding the configured default QoS class for one or more data flows. For instance, the indication may include a given QoS class to apply, possibly for a period of time. Such indication may be determined as a function of a property of the scheduling information (e.g. in the downlink control information (DCI)) and/or an indication by DCI.

For example, a condition for QoS classification may include reception of an indication for a given grant. For instance, a DCI may signal a given QoS class, for such QoS class, only data associated with such class may be multiplexed. Additionally and/or alternatively, the WTRU may multiplex data regularly on the grant then treat the whole TB as data with the signaled QoS class (e.g. in lower layers). Such indication may be determined as a function of a property of the scheduling information (e.g. in the DCI) and/or an indication by DCI.

For example, a condition for QoS classification may include data from a gating data set. For instance, the WTRU may associate a given non-default QoS class to a gating data unit.

For example, a condition for QoS classification may include a function of dependent data and/or data set. For instance, for a data unit that other units depend on (e.g. an FEC source packet, a video defining frame—e.g. I frame—, a gating data unit) a non-default (e.g. prioritized) QoS class may be assigned. For dependent, duplicated, and/or redundant data units, a different QoS class may be assigned (e.g. a default QoS class associated with the flow).

For example, a condition for QoS classification may include a function of systematic PDU within a set. For instance, the possibility of transmission and/or inclusion of buffered data of a systematic frame and/or data unit within a data flow (e.g. source data units that are encoded, systematic video frames, etc).

For example, a condition for QoS classification may include satisfying one or more control plane event. For instance, satisfying one or more mobility event condition, satisfying a conditional handover condition to one and/or more handover candidate. For example, upon satisfying a mobility, an RLM, a beam failure, or an RLF, the WTRU may associate a different QoS class with a data unit, possibly for a period of time associated with the CP event.

For example, a condition for QoS classification may include sensing an object and/or determining an outcome from a sensing or positioning procedure. For example, sending data may be configured or pre-associated with a given QoS class. Upon detection of an object as a function of sensing or a spatial computing service as an outcome of sensing, the WTRU may select a certain QoS class (e.g. non default or configured QoS class).

For example, a condition for QoS classification may include dropping and/or adding one ore more data flows. For instance, upon adding and/or dropping or more service or a data flow (e.g. from a multi-modal service or session), the WTRU may change the QoS class associated with the remaining data flow or dependent data flow.

For example, a condition for QoS classification may include synchronization between data flows. For instance, if synchronization between data flows is configured or indicated from the application or the core network, the WTRU may associated one QoS class when for data units when a dependent data flow is synchronized and/or another QoS class when the data flow is not synchronized and/or within a period of miss-synchronization (e.g. a remaining synch time is larger or lower than a threshold). If a common identifier is used (e.g. signaled from the application or the core network) to associated two flows, the WTRU may use the same QoS class for data units of both data flows. Once dissociated, the WTRU may revert to the default QoS classes configure for each data flow individually.

For example, a condition for QoS classification may include dropping and/or adding one ore more dependent data types. For instance, if the WTRU is configured to need X out of Y data units to decode an overall packet (e.g. an FEC encoded packet, a source video frame, etc.), the WTRU may select a given QoS class when X out Y have been successfully decoded, while the WTRU may associate a different QoS class when X out of Y have not been successfully decoded and/or if X′ out of Y units have been received, and/or if X″ units have been not acknowledged but received.

For example, a condition for QoS classification may include satisfying one or more event from the transport layer protocol (e.g. generating TCP acknowledgement (ACK), transmission of an out of order packet within a transport protocol session and/or connection, reading a specific value from the header of the transport layer protocol for a given packet, etc.). Once such condition is met, the WTRU may associate the associated data unit of the related RAN data flow with a given QoS class. The WTRU may be able to determine one or more properties of the transport layer protocol from a relay on top of the RAN protocol stack, which is used to de-cypher and/or decrypt the transport layer header and/or content if encrypted.

For example, a condition for QoS classification may include measuring a channel condition below or above a given threshold, or measuring a change in the channel conditions below or above a given threshold. Once such condition is met, the WTRU may associate a data unit with a given QoS class.

For example, a condition for QoS classification may include a function of whether the data unit is transmitted initially and/or retransmitted (e.g., or as a function of the retransmission number).

For example, a condition for QoS classification may include a function of the energy saving state of the network (e.g., which may be indicated to the WTRU) or the power saving state of the WTRU (e.g. whether DRX is used).

For example, a condition for QoS classification may include transmission and/or determination of successful transmission of dependent data type or a dependent data unit (e.g., possibly only from the same data flow or from a different data flow). For example, if a data unit x is successfully transmitted, the WTRU may determine QoS class B for data unit y. If a data unit x is not successfully transmitted, the WTRU may determine QoS class A for data unit y. In an example, y can be x+1. Data unit y can be an UL or a downlink (DL) data unit.

For example, a condition for QoS classification may include reception and/or successful reception of a dependent data unit on the downlink (e.g. on a PDSCH), possibly only from an associated data flow by configuration. For example, if a DL data unit x is successfully received, the WTRU may determine QoS class B for UL data unit y. If a DL data unit x is not successfully received, the WTRU may determine QoS class A for UL data unit y.

For example, a condition for QoS classification may include the remaining time associated with the SDU is below or larger than a configured threshold, where the remaining time is determined by the WTRU as the time until the flow's and/or SDU's PDB and/or PDU set delay budget (PSDB) is exhausted and/or the time until the discard timer associated with the packet expires (e.g., where such timer may be maintained at higher layers, for example, packet data convergence protocol (PDCP), or by the segmentation and/or multiplexing layer itself, for example, medium access control (MAC)).

A condition may be bound for a period of time (e.g. once satisfied) it is considered satisfied until the period of time (configured and/or predetermined) has elapsed. While the condition is met during the period of time, a differentiated QoS class may apply to the data unit. Once the period expires, the data unit is associated with a default QoS class and/or a reverted QoS class that was assigned before the condition was met. A condition may be bound to a subset of data flows (e.g. a QoS flow, data unit set, a DRB, logical channel (LCH), logical channel group (LCG), PDU set, etc.). Once satisfied, the WTRU may determine that it is applied only for the applicable set of data flows (which may be configured by higher layer signaling) and the associated QoS class is applied for the data unit. A condition may be bound to a subset data types (control, user data, system data, intelligence data (e.g., AI/ML), positioning data, sensing data). Once satisfied, the WTRU may determine that it is applied only for the applicable set of data type (e.g., which may be configured by higher layer signaling) and the associated QoS class is applied for the data unit. A condition may be bound to a subset of device capability. A condition may be bound to a subset of uplink grants, grant types (e.g. dynamic vs. semi-static/configured grants), a subset of grant indication properties, and/or a property of the grant scheduling indication (e.g. the DCI indication and/or as a function of the DCI scheduling parameters).

In 3G, 4G and 5G, all of the same corresponding entities are present in the Radio Access Network. In each generation the functions discussed above and others are split among defined logical nodes which can each exist in different physical pieces of hardware. For 4G, the architecture was such that all of the functions discussed above and more were all located in a single logical entity the eNB. In 5G, the logical nodes defined were the centralized unit (CU) and distributed unit (DU), and an option as implemented in open RAN (ORAN) is where the DU functions are split in the PHY between the DU and a radio unit (RU). But even with these logical entities they may all exist in a single piece of equipment, or two pieces of equipment one containing the CU another the DU and RU logical node, or three pieces of equipment that house the CU, the DU and the RU respectively. In 5G, the PDCP is in the CU logical entity, the RLC, MAC and some PHY functions in the DU and the lower PHY functions in the RU, if an RU is defined. In all cases regardless of the how the protocols are split between the logical entities the functionality of the PDCP, RLC and MAC protocols are the same and thus could be in different logical nodes in future generations as long as proper communication is defined between the logical nodes housing the various protocol layers. For example, a 6G narrowband (NB) may have the same logical entities like CU, DU and RU, and/or may have a different number even some that will handle user plane functions only and others control functions.

The current user plane interface, originally developed in 3G and 4G, was designed to meet best effort data with a minimum and guaranteed bit rate requirements, and not much beyond such requirement.

A new generation L2 interface may be thought of as a framework that may be forward compatible to support a variety of use cases of different requirements and data types, without having to support specific functionality for specific features and/or having to perform patchy solutions down the road. Such design can thus be configurable and/or flexible to adapt to different requirements and deployment options, without introducing unnecessary complexity. The following limitations are explained per protocol layer herein.

For example, the RLC layer may have a number of shortcomings, at least per the current design assumptions. For instance, automation repeat request (ARQ) may be considered slow to react to any latency-controlled application. ARQ was specifically useful due to avoiding having TCP's congestion avoidance mechanism kick in. TCP throughput suffers greatly when the residual link's loss rate is not within normal operational error loss rates. For instance, RLC window stalling may cause the delay of transmission of new PDUs. Windowing design may cause latency at the transmitter and may require larger buffer sizes, especially since PDCP already supports windowing for in and/or out of order delivery. For instance, header overhead may be a RLC layer limitation. RLC may often introduce unnecessary headers that could have been avoided by different protocol assumptions. Further, concatenation on top of MAC may reduce headers (e.g., secondary node (SN)/logical channel identities (LCIDs)). RLC sequence numbers may also be viewed as duplicated functionality given packets are sequenced at PDCP. For instance, increased segmentation, including the possibility of having numerous segments of segments upon retransmissions, may be a RLC layer limitation. Segmentation introduces sometimes unnecessary WTRU processing, latency (e.g., due to reassembly), and/or complexity. Segmentation may be caused by inclusion of medium access control-control elements (MAC-CEs). Segmentation may be caused by LCP, (e.g. due to traffic shaping in the first round and/or second round of resource allocation whereby multiple flows are contending for the same resources in a grant). In some cases, the WTRU can afford to wait for LCP buckets to fill up to allow transmission of a whole RLC SDU without having to allocate a segment of it in an available grant. There may be prioritization over some lower priority MAC-CEs if segment can be delivering a segment without segmentation. Segment size may not be known by NW for the last segment. Reassembly may be done in PDCP, as ARQ functionality exists in PDCP, but segmentation may be done in MAC. The segmentation offset (SO) info in a header may need to be present for CU architecture, for uplink transmission. The network can keep the segment in DU. Considering which functionality exists in PDCP, RLC may be viewed to have duplicate status reporting, duplicate sequencing, and duplicate packet discards. In a consolidated protocol design, such functionalities can be merged.

The PDCP layer may have limitations. For example, PDCP functionality in NR and LTE is maintained per radio bearer, thus increasing WTRU complexity with the number of radio bearers (RBs). PDCP functionality may be assumed to be maintained at the CU and is dependent on the radio bearer's termination node (e.g., master node (MN), secondary node (SN), dual connectivity (DC), split bearers, etc.), thus limiting flexibility of data routing and recovery. In the current PDCP design, bearers are semi-statically mapped to a fixed node (MN or SN, or split). In the current design of in-order deliver bearers, a higher priority packet may need to be transmitted in order, even though lower priority packets may be ahead of it in the queue. This may cause transmit window stalling, until lower priority SDUs of “in order” SNs are transmitted. There is a question about whether an RLC entity for each PDCP entity is needed, assuming a bearer structure is maintained. If this is not the case, a scheduling and/or mapping between PDCP entity and RLC entities may be needed. In addition to DU and/or CU architecture split, a DU, CU, and/or RU split it also possible, where the architecture follows a CU-DU-RU tree like structure. CU may not know what is configured by DU and/or RU if configured in MAC; there can a specified interface between DU and RU (e.g. similar to ORAN).

The service data adaptation protocol (SDAP) layer may have limitations. In LTE/NR, it is assumed that all packets in the same DRB have the same priority and in sequence delivery is beneficial to have and for TCP performance. However, with more advanced applications, data in the queue may have different priorities, timelines, and/or PDB, even though they may come from the same data flow. Furthermore, with QUIC replacing TCP, packets may arrive out of order and therefore there may nor be a strict need to deliver all packets in sequence. In NR and LTE, the concept of radio bearers is used to effectively manage QoS treatment and grouping of data from a given QoS flow. A bearer may be abstracted as a configurable logical combination of processing steps applicable to data such that transport of such data can be performed while meeting specific QoS requirements. The DRB concept thought comes to some limitation, whereby certain packets of a data flow need to be treated differently than others. One example is XR PDU sets, where even though both sets can belong to the same flow, one set can be treated differently than another and/or one PDU within the set may be more important that others in the same set. A PDU set in 5G-NR represents a DRB that is finite in time and in the number of packets. In a video flow, for example, I-frames and/or meta data of volumetric video may be more important than other packets and/or frames within the same flow. Limitation of DRB to meet QoS was discussed in NR XR, where mappings of a QoS flow to multiple DRBs was discussed, but deemed to complex to change at a later stage of 5G.

The MAC layer may have limitations. For instance, there may be limitations in the cross layer interactions. Interactions between the physical layer and upper layers have been mostly abstracted by parameters in MAC and/or cross-layer indications. For example, whether to fill a certain data type on a grant is modelled in NR based on use case-specific LCP restrictions (e.g. for URLLC, XR, non-terrestrial networks (NTN)), rather than a general network-controlled restriction indication. Several prioritization and/or buffer status reporting WTRU actions dependent on if remaining time was further specified in NR based on remaining time until the expiry of the PDCP discard timer. However, PDB is, in practice, more variable and may change for a given packet after the SDU packet arrival. Further, R19 NR supports temporary upgrades to LCH priorities based on the remaining time. For instance, there may be limitations in the fixed allocation of LCIDs. One issue observed in NR is the limited number of available LCIDs, which are used to identify data and various control elements. LCIDs are currently fixed in specifications, where there is fixed 1-1 mapping between MAC-CE type and LCID for example. However, many MAC-CEs may not be used by some WTRUs, depending on the supported features and/or WTRU capability.

Data plane buffer management (e.g., storage, reporting, and/or transmission) may be implemented. In some examples, the WTRU may use a separate protocol architecture “data plane” (DP), and/or information plane, separate from the user plane protocol stack for specific data types (e.g., AI/ML collected data, sensing data, low priority data collected for an external server, measurements from sensors, etc.). In a data plane architecture, certain protocol functions may be simplified and/or removed. Further, within the WTRU, there may be prioritization between user plane data and data plane data, prioritization between user plane control elements and data plane elements, and/or prioritization between data and control elements.

Example situations are thus envisioned. For example, an example situation may include how to transfer large volume of system and/or operational data characterized by latency requirements that may vary in the range (e.g., HRLLC, infinite), for instance, not using radio resource control (RRC)/non-access stratum (NAS), SRBs and/or DRBs. An example situation may include how to manage differentiated treatment between CP, UP and DP data. Priority of the data plane may often be assumed as lower than best effort data in user plane, except for some cases and/or conditions where it may be temporarily prioritized over user plane data. An example situation may include how to enable a data plane mechanism that may be controlled for transmission, reporting, and storage of DP data (e.g., in terms of data volume and time), without impeding on user plane traffic. An example situation, for DP data with “infinite” and/or undefined latency requirement, may include how to control and manage WTRU buffers. An example situation may include how to transfer operational data using IP protocols and/or without using IP protocols. An example situation may include how to control when the WTRU collects, reports, and makes data plane data available to RAN data plane layers (e.g. for the purpose of reporting BSR to the network, reporting of RAN related MAC-CEs, transmission of DP data, etc.).

In some examples, a data plane protocol stack may have a subset of the user plane sub-layers and/or protocols and/or reduced functionality sublayer protocols. For example, a WTRU may be configured with a user plane and a data plane (DP) protocol stack, in which the data plane may be used to process data collected for AI/ML and/or sensing. A WTRU may be configured with one or more parameters for data plane buffer management. For instance, the one or more parameters for data plane management may include maximum stored data volume and a storage period timer. The one or more parameters for data plane management may include a temporal priority timer and more than one LCH priority and/or PBR. The configuration may be per PDCP entity, per SDAP entity, per data type (e.g., ML vs sensing), per collection data type, per collection data plane LCH and/or RB, per logical buffer, per collection data unit, and/or per collection data unit set.

In some examples, upon the data plane data arrival, the WTRU may store and/or generate data plane data. The WTRU may store and/or generate data plane data possibly conditioned on reception of a generation request from the network. The WTRU may start a storage period timer (e.g. for the associated data flow and/or data unit). Upon expiry of the storage period timer, the WTRU may discard the associated SDU. The WTRU may increment the amount of stored data volume by the amount of collection data that has arrived. For instance, if the amount of stored data volume is larger than a threshold, the WTRU may flush and/or discard X bits and/or units of the fist stored data in this first in-first out (FIFO) buffer, where X may be configured and/or equal to the amount of data arrival to the LCH's buffer.

In some examples, upon the data plane data arrival, the WTRU may trigger reporting of a data plane buffer status report if one or more of the following conditions are met. For example, the WTRU may trigger reporting of a data plane buffer status report if the buffered user plane data is of priority less than a threshold. The WTRU may trigger reporting of a data plane buffer status report if the buffered user plane data volume is less than a threshold. The WTRU may trigger reporting of a data plane buffer status report if DL signaling is received from the network polling and/or requesting for a DP BSR. The WTRU may trigger reporting of a data plane buffer status report if the storage period timer has expired and/or is less than a threshold. The WTRU may trigger reporting of a data plane buffer status report if the amount stored data volume is larger than a threshold (e.g. maximum stored data volume). The WTRU may trigger reporting of a data plane buffer status report based on load, network energy saving (NES) state, and/or time of the day condition.

In some examples, upon the data plane data arrival, the WTRU may make data plane data available for transmission at lower layers (e.g. PDCP and/or MAC) if one or more of the following conditions are met. For example, the WTRU may make data plane data available for transmission at lower layers if the buffered user plane data is of priority less than a threshold. The WTRU may make data plane data available for transmission at lower layers if the buffered user plane data volume is less than a threshold. The WTRU may make data plane data available for transmission at lower layers if DL signaling is received from the network polling and/or requesting for a DP BSR. The WTRU may make data plane data available for transmission at lower layers if the storage period timer has expired and/or is less than a threshold. The WTRU may make data plane data available for transmission at lower layers if the amount stored data volume is larger than a threshold (e.g. maximum stored data volume). The WTRU may make data plane data available for transmission at lower layers based on load, network energy saving (NES) state, and/or time of the day condition.

In some examples, upon the data plane data arrival, if DP data is made available to lower layers (e.g. MAC and/or PDC), the WTRU may start a temporal priority timer associated with the data unit or data flow. Upon expiry of a temporal priority timer, the WTRU may upgrade priority and/or PBR of a DP data flow to the next higher configured non-default priority and/or PBR and restarts the timer.

In some examples, for a received grant, the WTRU may trigger transmission and/or multiplexing of the data plane data if DP data transmission condition is met. DP data transmission condition may include reception of indication from the network to transmit and/or after transmission of a DP BSR.

In some examples, for a received grant, the WTRU may prioritize the multiplexing of DP data per the following. For example, WTRU may allocate resources to data plane data in the grant in a second round after PBR allocation round of user plane LCHs, (e.g., the WTRU may exclude data plane data from the first round of resource allocation in LCP. For example, the WTRU may serve data plane LCHs up to PBR only (e.g., strict traffic shaping compliance), for instance, in the second round after all user plane data has been allocated.

A property of scheduling information (e.g., an uplink grant and/or a downlink assignment) may consist of at least one of the following: a frequency allocation; an aspect of time allocation, such as time instance or/and a time duration; a priority; a modulation and coding scheme; a transport block size; a number of spatial layers; a number of transport blocks to be carried; a transmission configuration indicator (TCI) state and/or sounding reference signal resource indicator (SRI); a number of repetitions; whether the grant is a configured grant type 1 (e.g., WTRU immediately using the configured UL resources after receiving the configuration information), type 2 (e.g., WTRU waiting until an explicit MAC-CE indication before using the configured UL resources) and/or a dynamic grant.

An indication by DCI, and/or an indication, may consist of at least one of the following: an explicit indication by a DCI field and/or by radio network temporary identifier (RNTI) used to mask cyclic redundancy check (CRC) of the physical downlink control channel (PDCCH). An implicit indication by a property such as DCI format, DCI size, control resource set (coreset) or search space, aggregation level, identity of first control channel resource (e.g., index of first control channel element (CCE)) for a DCI, where the mapping between the property and the value may be signaled by RRC and/or MAC; an explicit indication by a DL MAC-CE.

Channel conditions may include conditions relating to the state of the radio and/or channel, which may be determined by the WTRU from one or more of the following: a WTRU measurement (e.g., layer 1 (L1)/signal-to-interference plus noise ratio (SINR)/reference signal received power (RSRP), channel quality indicator (CQI)/modulation and coding scheme (MCS), channel occupancy, received signal strength indicator (RSSI), power headroom, exposure headroom), layer 3 (L3)/mobility-based measurements (e.g. RSRP, reference signal received quality RSRQ, s-measure), a radio link monitoring (RLM) state, and/or channel availability in unlicensed spectrum (e.g. whether the channel is occupied based on determination of an listen-before-talk (LBT) procedure and/or whether the channel is deemed to have experienced a consistent LBT failure).

Gated and/or periodic data sets may include the following. For example, a gated traffic data flow may be defined as a data set, where there is a subset of “gating PDUs” and non-gated PDUs. Transmission of a gating PDU may enable the transmission of non-gating PDUs. If PDU x arrives every y millisecond (ms), and PDU x is a gating systematic PDU that enables a gated transmission. PDU x+1 may not be transmitted if PDU x is not transmitted or if PDU x is not deemed to be transmitted successfully (e.g. acknowledged). In one example, if PDU x arrives and/or is transmitted at time instance t, all PDUs between t and t+y are not transmitted unless PDU x is transmitted and/or transmitted successfully. An example may be video traffic with systematic frames. For instance, some video applications may not benefit from the transmission of frames following a systematic frame, as the picture may not be complete without it (e.g., systematic frame should be fully transmitted before transmission of subsequent frames).

As discussed herein, “allocating bits to a grant” and/or “serving a data flow” may refer to allocation of bits and/or UL resource within a given grant when constructing a transport block for that grant. For each bit allocated to a grant, it may be assumed that the WTRU may transmit such bit on the associated uplink grant (e.g. a PUSCH transmission). The use of the term logical channel does not imply the existence of an RLC and/or a DRB. LCH may be replaced with the term “data flow” to buffer packets from a same QoS flow or the same QoS class and/or treatment. A data flow may also refer to a logical buffer in a protocol layer used to group SDU sets and/or PDU sets, which may need to be treated similarly. As discussed herein, LCH, logical buffer, PDU set, and data flow may be used interchangeably.

Remaining time associated with the SDU may refer to the remaining time determined by the WTRU as the time until the flow's/SDU's PDB/PSDB is exhausted and/or the time until the discard timer associated with the packet expires (e.g., where such timer may be maintained at higher layers, for instance PDCP, or by the segmentation and/or multiplexing layer itself, for instance, MAC).

Data type as discussed herein may refer to one of the following types: user plane data, control plane data (e.g. SRB, NAS data), system data, sensing data, positioning data, model transfer data, computing/operational data, measurement data, and/or more generally data plane data.

UL traffic shaping envelopes may be defined. An UL traffic shaper is a scheduling implementation which may enforce that departing UL traffic complies to a given traffic envelope and which buffers, deprioritizes, and/or discards non-compliant traffic, at least in one round of resource allocation of bits to a grant. Examples may include one or more of the following: leaky bucket and dual leaky bucket, with shaping exceptions when some conditions are met. Multiple shapers where one or more is applicable for a given time/grant. When more than one is applicable, the min shaping water level of them is taken as the overall limit; max burst size shaper (E=burst size); deterministic shapers for periodic traffic E=A(period)/period; time variant shapers (e.g., enabled by NW signaling to control shaping parameters), e.g. a leaky bucket with dynamically signaled shaping parameters (r, b, P, BSD); shortest remaining time first, among buffered data units applicable for the grant; highest static priority first (e.g. highest QoS class), among buffered data units applicable for the grant; first in first out, among buffered data units applicable for the grant; no shaping (e.g., a data flow is not limited or limited only to the size of the grant).

The WTRU may maintain a UL traffic shaping bucket (e.g. Bj) for each data flow, each QoS class, each UL traffic shaping envelope, and/or per WTRU and/or MAC entity (e.g. for all data flows). When serving buffered data from a given flow and allocating UL resources in the grant to it (e.g. bit allocation in the TB), the WTRU may decrease the bucket by the value of the served buffered bits. The water level in the bucket (e.g. Bj) may be negative at some time, possibly for some exceptions (e.g. when using a non-default envelope or when serving data from data units from a given QoS class). For a given grant, the WTRU may serve buffered data to the grant from each flow up to the water shaping level (e.g. Bj), at least in a first allocation step and/or round. In a second round(s), the WTRU may allocate remaining resources in the grant according the same and/or a different envelope and/or without shaping at all. The water level (Bj) may be decreased in the first and/or the second round(s) and/or resource allocation.

For a given data flow for which the WTRU maintains a shaping bucket, should the WTRU change the shaping envelope for a subset of data units, the WTRU may update the bucket as follows: the water level (Bj)=Bj+the fill rate of the applicable envelope “r” multiplied by time since the bucket was last updated. The WTRU may be configured and/or preconfigured with a bucket water level (Bj) update period, where the WTRU may update the value once every such period. For a given bucket, if the non-default shaping is applied (as discussed herein) for a given data unit or a grant, the WTRU may update the water level according to the applicable non-default shaping rate “r′”, where Bj+=r′ times the time since the last update to Bj or an update period configured for the shaping envelope. The WTRU may fill the bucket with the value “b” of the applicable envelope. The WTRU may assume an updated bucket size of (BSD times r) while the applicable envelope is used for a given data unit.

NW knowledge of the shaping parameters and/or envelope may include the following. If the WTRU autonomously changes any shaping parameters, the WTRU may notify the serving cell (e.g. part of assistance info and/or a MAC-CE).

The WTRU may be configured with an overall UL shaping envelope, which the WTRU may use to limit the amount of data allocated to UL transmissions across all buffered data flows. Such an envelope may be used only conditionally (e.g. while a timer is running, upon reception of an indication from the network, if configured, upon determining congestion at the WTRU or the serving cell, and/or upon transitioning to an energy saving state).

When the WTRU maintains a single shaping bucket for a data flow and/or for the WTRU, and the shaping envelope changes for a given data unit, grant, TB and/or period, the WTRU may reinitialize and/or set the water level in the bucket “Bj” to the configured value b′ of the newly applied envelope and/or according to the associated fill rate r′ multiplied by the update period. When the WTRU applies an exception from shaping (e.g. as discussed herein), the WTRU may decrease the value of Bj by the amount of non-shaped data (e.g., in addition to the shaped data) and/or increase the value of Bj by that amount prior to multiplexing data for the grant.

The MAC sublayer may be defined as follows. The MAC layer remains an essential interface between the physical layer and higher layers, controlling QoS and scheduling. MAC therefore may remain as a component in a protocol layer design (e.g., to control multiplexing of data flows, scheduling, and reporting control info reliably). The following functionality may be provided by a MAC entity. For example, a MAC entity may provide mapping between logical channels and transport channels, ensuring proper data flow. A MAC entity may provide multiplexing or demultiplexing. The MAC sublayer efficiently combines or separates MAC service data units (SDUs) from different logical channels into/from transport blocks. These TBs are then delivered to and/or from the physical layer using transport channels. A MAC entity may provide scheduling information reporting, including scheduling requests and buffer status reports. A MAC entity may provide hybrid automatic repeat request (HARQ). Error correction is achieved through HARQ, where each cell (e.g., in the case of carrier aggregation (CA)) has a dedicated HARQ entity to handle retransmissions and ensure reliable data transmission. A MAC entity may provide dynamic scheduling. Prioritization of the WTRU is managed by dynamic scheduling, which allocates resources based on varying priorities to enhance overall system performance. A MAC entity may provide logical channel prioritization (LCP). Within a WTRU, logical channels are assigned priorities to determine their order of resource allocation and access to the available transmission resources. A MAC entity may provide handling overlapping resources. The MAC sublayer efficiently manages overlapping resources within a single WTRU, including prioritization between dynamic grants, configured grants, and scheduling request (SR) resources, thus ensuring optimal utilization. A MAC entity may provide padding and control elements. When necessary, the MAC sublayer adds padding bits to ensure proper alignment with the uplink grant size and the number of bits provided to the physical layer, after addition of all buffered data and triggered MAC control elements.

The RLC sublayer may be defined as follows. The following functionality may be provided by a RLC transmit entity. For example, a RLC transmit entity may provide ARQ retransmissions (e.g., acknowledged mode (AM)). A RLC transmit entity may provide Segmentation (AM and/or unacknowledged mode (UM)) based on transport block size (TBS) and size indicated by MAC. For instance, the RLC controls the timing of PDU construction and delivery to lower layers, which is determined based on the transmission time made available by MAC as a function of grant availability, latency of data, and/or TB construction time. At such time, RLC determines whether segmentation is required for a given SDU. For instance, a retransmitted segment may be segmented again. Assuming this type of retransmission is used instead of HARQ, the Tx entity needs to keep track of a “Segment tree” to recover a single PDU transmitted. For instance, segmentation can be considered in other layers (e.g. in PDCP and/or MAC) in alternate designs. For example, a RLC transmit entity may provide concatenation (AM and UM), in LTE but not in NR RLC. Such functionality sits on top of MAC, with the aim to save on LCID/SN bytes. For example, a RLC transmit entity may provide header addition (AM and UM), including indication of sequence numbers, segment offset (SO), and segment information (SI) in case of segmentation. For instance, sequencing can be considered as a redundant and/or induced functionality (e.g. when already done in PDCP). For example, a RLC transmit entity may provide polling a corresponding entity (AM) for feedback for transmitted SDUs, asking for reception of status reports.

The following functionality may be provided by a RLC receive entity. For example, a RLC receive entity may provide reassembly of PDUs of a segmented SDU and/or delivery to upper layers (AM and UM). For instance, maintenance of a receive window and a timer for reassembly. A RLC receive entity may provide discarding of PDUs within an SDU that cannot be re-assembled due to loss (UM). For example, if a PDU that is a segment of an RLC SDU is lost, the remaining PDUs of the same SDU can be discarded, as there is not possibility to retransmit a lost PDU. A RLC receive entity may provide discarding of duplicate PDUs (AM), (e.g. due to PDCP duplication and/or due to an unnecessary retransmission due to an ACK/negative acknowledgement (NACK) HARQ feedback error. This functionality can be performed in combination with PDCP in one possible design. A RLC receive entity may provide delivery of a ACK/NACK status reports per PDU (AM).

The PDCP sublayer may be defined and provide the following functionality. For example, the PDCP may provide bearer management. For instance, data routing, split bearers, dual connectivity etc. Such constructs can be viewed as artificial bucketing of data and may not be strictly necessary. DC may be viewed as not as important for 6G deployment. The PDCP may provide packet duplication and/or routing. The PDCP may provide discarding of duplicates and outdated packets (e.g., duplication, forward error correction (FEC), duplicates resent due to HARQ NACK/ACK errors, etc.). The PDCP may provide integrity protection and ciphering. The PDCP may provide sequence numbering. The PDCP may provide reordering. For instance, in and/or out of order delivery (e.g. lost packets come later, PDUs sent on multiple carriers arrive at different timelines, etc.). The PDCP may provide retransmissions (e.g. FEC, upon handover for unacknowledged PDUs, RRC re-establishment and/or RLF, etc.).

In some examples of architecture, the gNB may be in a combined CU and DU (e.g., no split). In other examples, CU and DU may be split and some functions (e.g. PDCP high, SDAP, and/or some core network functions) may be in the CU and other functions (e.g. RLC, PDCP low, MAC, physical (PHY)) may be at the DU. PDCP may also be at the DU in one architecture (e.g. to have a simple piece of equipment that will not have any layer 2). In another example architecture split, radio units (RUs) may be used and the gNB may be split over CU, DU, and/or RU, where some functions (e.g. PHY, MAC, and/or RLC) may be located and managed at the RU.

In one example architecture, the split between DU and RU may be in the mid PHY layer (e.g. where upper PHY layer resides in the DU and lower PHY layer resides in the RU). In one example architecture the user plane and the data plane may be terminated in different logical entities. As discussed herein, a statement indicating a functional split may refer to a split in the CU, DU, and/or RU at the transmit and/or the receive side of the protocol stack.

The following terms can be used herein in the context of functional splits from the network's perspective. For example, Control Plane (C-Plane) may refer specifically to real-time control between DU and RU. User Plane (U-Plane) may refer to user generated data, sample data transferred between DU and RU. Synchronization Plane (S-Plane) may refer to traffic between the RU or DU to a synchronization controller (synchronization controller messages). High-PHY may refer to portions of the PHY processing on the DU side of the fronthaul interface, including FEC encode and/or decode, scrambling, and modulation and/or demodulation. Low-PHY may refer to portions of the PHY processing on the RU side of the fronthaul interface, including fast fourier transform (FFT)/inverse FFT (iFFT), digital beamforming, and physical random access channel (PRACH) extraction and/or filtering.

Medium access control (MAC) architecture may be implemented. A MAC entity may be mapped to one or more HARQ entities, where each HARQ entity resembles a set of HARQ process IDs, a given cell, a given carrier, a given bandwidth part (BWP), and/or a certain RU. For example, a MAC entity configured with multiple carriers has a single HARQ entity per carrier. In another example, a single HARQ entity may be configured and used for multiple carriers operated by the same MAC entity, whereby the MAC entity may one or more of the following. For example, the MAC entity may be configured with a mapping of a subset of HARQ processes and a carrier, bandwidth part (BWP), and/or an RU. The MAC entity may be able to retransmit a TB from one carrier, bwp, and/or RU to another. The MAC entity may be configured with a subset of HARQ processes that are shared amongst a plurality of carriers, bwps, and/or RUs. The MAC entity may be associated with a “multi-carrier” single cell (e.g. a single physical cell identity (PCI) may be used to identify such cell and/or MAC entity).

In some examples, operation of multi-carrier in a single cell may be realized by having multiple active bandwidth parts (e.g., for each active carrier), and carriers can be activated and/or deactivated by using signaling for BWP activation and/or deactivation. In such an example, the WTRU may assume that a single HARQ entity is used for the active BWPs and/or carriers. RRC may configure which BWPs are considered to be part of which carrier, and an associated cell index (e.g., PCI).

A flexible MAC architecture may support interactions between MAC and the physical layer based on priority in a future compatible manner which supports a variety of use-cases. For example, the WTRU PHY may perform a certain action (e.g. transmit sounding reference signals (SRS), increase blind decoding, etc.) when the latency associated with the data exchanged becomes critical.

In some examples, the WTRU PHY can transmit more SRS for channel estimation when the latency (e.g. remaining time) associated with the data is below or above a configured threshold. A WTRU MAC entity can therefore support a forward-compatible model for PHY-MAC interface and inter data flow and/or control prioritization, considering one or more of determination and modelling of priority and latency timelines in MAC based on associated packet delay budgets, configuration of network-controlled prioritization parameters which can by dynamically signaled, and/or cross-layer indications.

In LTE and NR, a per LCH and/or DRB FIFO buffer is chosen as it is assumed that all packets in the same buffer have the same priority and in sequence delivery is beneficial to have for TCP performance. However, with more advanced applications, data in the queue may have different priorities, timelines, and/or PDB, even though they may come from the same data flow. Furthermore, with QUIC replacing TCP, packets may arrive out of order and therefore there may not be a strict need to deliver all packets in sequence.

Transmission of a non-delay critical packet ahead of a delay critical one because of its arrival time order may lead to further delay to transmit the delay critical SDU. A forward compatible framework for queue management may therefore consider one or more of the following. For example, a forward compatible framework for queue management may consider head of line packet selection. A forward compatible framework for queue management may consider just in time sequencing and/or sequencing by transmission order. A forward compatible framework for queue management may consider buffering and/or transmission order selection based on upper layer indications and/or packet marking (e.g. QoS class). The WTRU may maintain a set of buffers per QoS class, priority, PDB range, data type, (e.g., instead of buffering per DRB), and such can be left to WTRU implementation, as long as the network is aware of the transmission order expectation. A forward compatible framework for queue management may consider how and when to report buffer status assuming that data is not buffered per data flow. A forward compatible framework for queue management may consider whether packets and/or PDU sets of a data flow can be buffered together or not into the same logical buffer. A forward compatible framework for queue management may consider data flows and/or packets that require the same QoS and/or over the air treatment may be aggregated into the same logical buffer. A forward compatible framework for queue management may consider handling dependencies between PDUs within the same PDU set. A forward compatible framework for queue management may consider handling dependencies between PDUs of different data flows (e.g., synchronization threshold dependency).

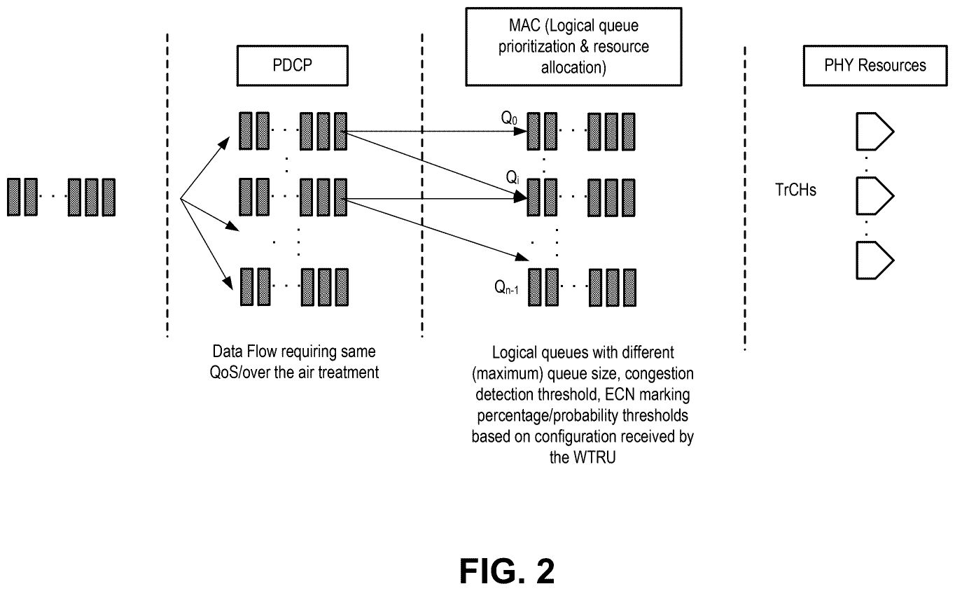

FIG. 2 illustrates an example buffer/queue management using logical queues in the WTRU. In this example, the air interface protocol architecture may not have the legacy DRB, and may not have RLC as a protocol layer. Logical channels may be used for multiplexing and/or demultiplexing of MAC SDUs. Selection and/or prioritization of MAC SDUs for resource allocation may be based on one or more of logical channel configuration (e.g. logical channel restrictions, logical channel priority, etc.), and logical queue configuration (e.g. queue size, delay budget (maximum or remaining), priority, etc.). A queue may be configured into the WTRU with one or more of the following parameters: low latency, low loss, scalable throughput (L4S) capable, non-L4S capable, maximum delay budget, maximum queue size, queue size threshold for congestion detection for non-L4S traffic (e.g. if the queue is for traffic on non-L4S capable transport, one or more congestion detection thresholds for L4S traffic, for instance, the queue if for traffic on L4S capable transport), one or more percentage and/or probability thresholds for explicit congestion notification (ECN) marking for L4S traffic, and/or logical queue mapping restrictions (e.g. data that cannot be mapped to the logical queue). The WTRU may also be configured with one-to-one and/or one-to-many associations between a flow of data requiring same QoS and/or over-the-air treatment and/or logical queues. A data within a data flow that requires the same QoS and/or over-the-air treatment may be identified by one or more of QoS Flow ID, an ID of a data type, one or more first PDU set IDs, one or more second PDU set IDs, etc. Mapping between data of a data flow and/or logical queue may be based on the logical queue configuration, and/or one or more of the following attributes of the data: the IDs of the data, (e.g., remaining) delay budget, L4S-capable transport marked, non-L4S transport marked (e.g. ECN-capable transport marked, not ECN-capable transport marked), etc. The WTRU may also be configured with a mapping between logical queue and traffic channel (TrCH).

In some examples, a WTRU may perform one or more of the following steps. For example, a WTRU may receive configuration for one or more logical queues and/or a configuration for mappings between a flow of data requirement same QoS and/or over-the-air treatment and logical queues. The WTRU may receive data from upper layer. The WTRU may perform classification of the data and/or marking of the data for a QoS treatment. The WTRU may map the received data to a logical queue based on one or more of the mappings between data of data flows and logical queues, configured into the WTRU.

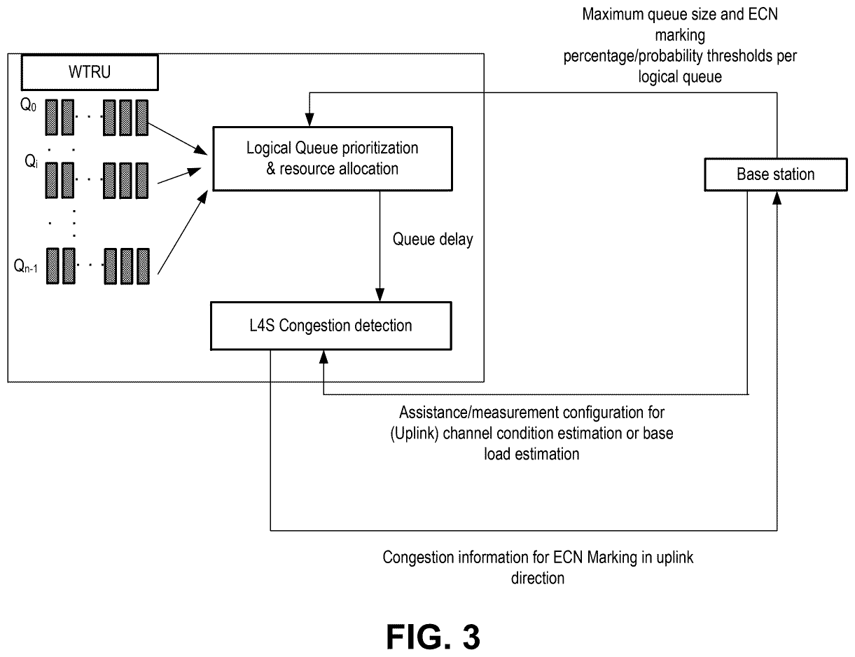

FIG. 3 illustrates a procedure for a WTRU-assisted L4S ECN marking at the base station for in uplink direction. In some examples, the WTRU may perform one or more of the following steps. For example, the WTRU may receive configuration for one or more logical queues, and/or configuration for mappings between a flow of data requirement with same QoS and/or over-the-air treatment and logical queues. The WTRU may receive data from upper layer. The WTRU may perform classification of the data and/or marking of the data for a QoS treatment. The WTRU may map the received data to a logical queue based on one or more of the mappings between data of data flows and logical queues, configured into the WTRU. The WTRU may receive assistance and/or measurement configuration for estimation of an uplink channel condition and/or a base station load. A WTRU may detect congestion, for instance, based on queue delay and/or logical channel queue configuration (e.g. congestion detection thresholds, percentage and/or probability thresholds for ECN marking, etc.). The WTRU may report congestion information (e.g. percentage of packets that base station uses for ECN marking for L4S for ECN marking at base station). The WTRU may report congestion information using an L2 control PDU (e.g. MAC-CE).

In some examples, the RRC may configure the LCID allocation and/or to have a space of LCIDs that can be allocated by configuration and/or dynamic assignment. LCIDs can be different for MAC-CEs and data. For example, a MAC header design may be considered for data and/or control, where the L field may be optionally present.

In some examples, data may be routed and/or mapped from a MAC entity to multiple HARQ entities, multiple carriers, BWPs, and/or multiple RUs. The same solution may apply to routing and/or mapping data between an RLC entity and/or a “PDCP low” entity and multiple MAC entities (e.g. assuming a functional split where the DU is located at the MAC entity).

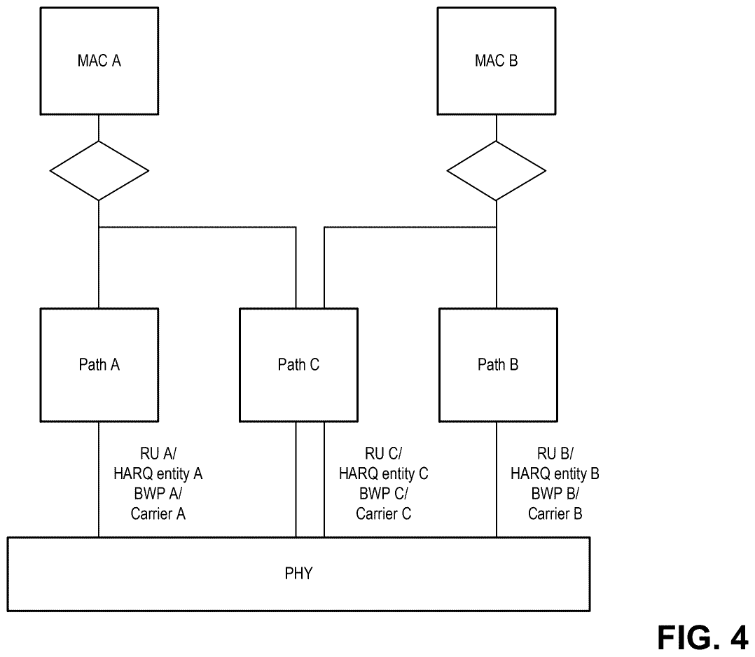

In some examples, a given MAC entity may be mapped to more than one HARQ entity, RU, carrier, and/or BWP, herein called a MAC path, and a given HARQ entity, RU, carrier, and/or BWP may be mapped to many MAC entities, as shown in FIG. 4. A MAC entity may be configured with multiple MAC paths, including a default an non-default paths. Initially, the MAC entity may be configured to transmit the TBs to the default MAC path. If certain configured conditions are fulfilled, the MAC entity may route and/or map TBs to the alternate and/or non-default paths instead. In some examples, the MAC entity may be checking the conditions on a packet to packet level and may determine to transmit the packet to the default path and/or the alternate one, for instance, as a function of QoS classification (e.g. marking).

In some examples, the conditions may be checked at one time instance, the MAC path used to transmit the TBs may be determined and may be used for all subsequent packets until the next time instance for checking the conditions. The checking for the conditions may be done periodically (e.g., each MAC entity configured with different periodicities for determining the path). There may be other criteria to determine when the condition is to be checked. For example, the MAC entity may be configured to use the default path until the total amount of outstanding data for that MAC entity over that path (e.g., in terms of number of bits) is less than a certain configured threshold, and once that has passed the WTRU may check the conditions to determine whether the next packet, and/or a certain number of packets, may be sent to the alternate RLC instead.

In some examples, a combination may be possible, where periodically MAC may decide the default path, and the WTRU may decide, on per packet-to-packet basis, if the default path and/or the alternate path is to be used. In some examples, there may be a configured maximum amount of data (e.g., in terms of number of SDUs, and/or total number of bits) a given MAC entity may transmit to the alternate path within a given configured time. Similar restrictions may be applied to the default path. In some examples, there may be a configured maximum amount of data (e.g., in terms of number of packets, and/or total number of bits) a given MAC entity may have pending acknowledgement over the alternate path, and/or the default path.

In some examples, the MAC entity may be configured with a certain prohibit timer for switching between the default and alternate paths (e.g., no switching within less than x ms). In addition and/or instead of the prohibit timer, a data size amount may be specified (e.g., no switching until n number of packets or z number of bits are transmitted via the newly chosen path). Some packet types (e.g., low priority packets, data of certain types, packets of low importance, packets having very high delay budget, a QoS class or a set of classes, etc.) may be configured to be sent via the default path and/or a non-default path.

In some examples, the WTRU may receive an indication (e.g., a MAC-CE and/or an indication by DCI) that activates and/or deactivates the alternate path for a given MAC entity. For example, if the indication is for deactivation, then the MAC entity may stop transmitting packets to that path (e.g., until a subsequent activation message is received). The deactivation and/or activation may have a time duration value associated with it (e.g., indicated within the MAC-CE, for instance, as index to a time duration value, and/or configured separately before the MAC-CE was sent, for instance, in a previous RRC configuration of the MAC entities and/or paths), and the WTRU may apply the activation and/or deactivation for that period.

Radio link control (RLC) and packet data convergence protocol (PDCP) architecture may be implemented. Many RLC functionalities may be duplicated and may be performed by other layers, and/or some functionality is not necessary if the protocol layer is combined with another layer.

RLC and/or PDCP can be effectively combined into a single protocol (e.g., a Packet Control and Convergence Protocol (PCCP)), to reduce the amount of redundant functionality and overhead (e.g. sequencing and headers) that is introduced by having two separate layers. The naming is an example and the combined layer may equally be called as PDCP or RLC as well.

In some examples, and assuming that RLC is removed, one advantage of removing RLC may be to allow performing real time and/or last minute functions and decision (e.g. related to PDU construction and/or SN assignment) at the time of transmission. Assuming that RLC is removed, a framework may be available already when RLC transport mode (TM) is used but there may be a need to address the shortcomings. Assuming that RLC is removed, and in absence of DU and/or CU split, merging RLC with PDCP may be made easier. But even if there is a DU and/or CU split, ARQ could be done with new retransmissions in MAC and/or by the combined layer. Split architecture may be made such that the combined layer resides at DU, or it can be in CU which allows cross-DU retransmissions. Assuming that RLC is removed, segmentation and/or concatenation may be optional, conditional, and/or configured per LCH/flow, data type, etc. Whether there is a need to segment for all data types may be discussed. Segmentation may be left for the MAC layer (e.g. in LCP) and/or in the combined layer and reassembly may happen at the same layer where segmentation happens. Conditions for segmenting a segment may be considered. Certain SDU parts that are already received may not need to be retransmitted.

ARQ in relation to RLC and PDCP being combined may be considered. For example, ARQ functionality may be moved to a combined RLC/PDCP layer. Assuming HARQ feedback is improved in 6G (e.g. by allowing two-level HARQ feedback or HARQ ACK and/or NACK on a MAC-CE and/or a physical uplink shared channel (PUSCH) transmission), the likelihood of NACK and/or ACK error may be less critical. It is therefore debatable whether there is a need to support ARQ for all cases, assuming the reliability of HARQ feedback is improved. Additionally and/or alternatively, ARQ functionality may be there to dynamically compliment HARQ and/or may be triggered dynamically based on data timeline (e.g., for retransmission of delay critical data) and/or coverage conditions (e.g. when the WTRU becomes coverage limited). PDCP duplication may be replaced and/or modeled as an ARQ retransmission.

Assuming DRBs are removed and/or made more elastic, and RLC is combined, the following aspects may be considered. For example, PDCP may route packets on more dynamic cases to MAC LCHs. There may be no one-to-one mapping of DRB to LCH, but rather PDCP may route a packet to an LCH logical transmission buffer dynamically based on the different metrics (e.g. remaining time, priority, QoS class marking, etc.). How to enable out of order transmission (e.g., regardless of PDCP count) may be considered. How to perform transmission order (e.g. count values) when a combined RLC and/or PDCP window is used for reassembly may be considered. How to assign and/or increment SN values may be considered.

Assuming RLC remains, RLC may by bypassed (e.g. TM mode) for packets that are not segmented or do not require ARQ. Assuming RLC remains, RLC mode selection may be done per SDU, data type, and/or QoS class. Assuming RLC remains, consideration may be required as to whether RLC is needed in some cases (data types, broadcast vs. single case, control data, etc.).

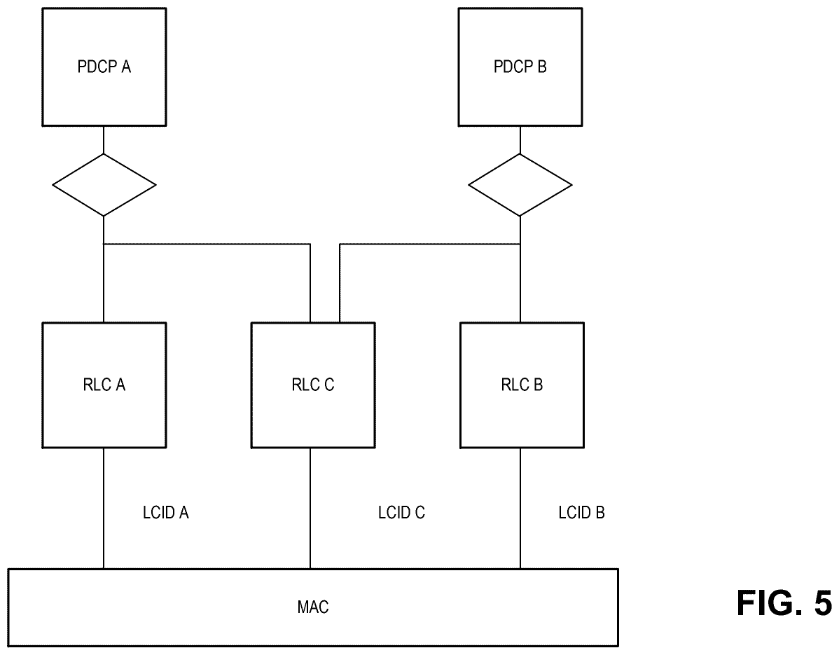

In some examples, a given PDCP entity may be mapped to more than one RLC entity, and a given RLC entity may be mapped to many PDCP entities, as shown FIG. 5. For the example in FIG. 5, the PDCP entity A is mapped to an RLC entity A (e.g. a default RLC entity) and an alternate and/or a non-default RLC entity (RLC C). PDCP entity B is mapped to an RLC entity B (default RLC) and an alternate RLC entity (RLC C). For example, LCID C has a higher priority (e.g., or PBR) than LCID A and LCID B. Initially, the PDCP entities are configured to transmit the PDCP packets to the default RLC entity. If certain configured conditions are fulfilled, the PDCP entities may push the packets to the alternate RLC entity instead. In one example, the PDCP entity may be checking the conditions on a packet to packet level, and may determine to transmit the packet to the default RLC entity and/or the alternate one. In a an example where RLC and PDCP are combined (e.g. in a PCCP), RLC entities herein may be replaced with MAC entities.

In some examples, the conditions may be checked at one time instance, the RLC entity to transmit the packets to may be determined, and this may be used for all subsequent packets until the next time instance for checking the conditions. The checking for the conditions may be done periodically (e.g., where the periodicity can be the same for all PDCP entities, and/or each PDCP entity configured with different periodicities for determining the RLC entity). There may be other criteria to determine when the condition is to be checked. For example, the PDCP entity may be configured to use the default RLC entity until the total amount of outstanding data for that PDCP entity over that path (e.g., in terms of the number of packets or actual number of bits) is less than a certain configured threshold, and once that has passed the WTRU may check the conditions to determine whether the next packet, and/or a certain number of packets, may be sent to the alternate RLC instead.

In some examples, only one PDCP may use an alternate RLC entity at a given time. For example, if a PDCP entity has determined to use the alternate RLC entity for a given time (e.g., until the next periodicity for checking the conditions), the other PDCP entities may refrain from transmitting their packets to the shared alternate RLC.

In some examples, a combination is possible, where periodically PDCP may decide the default RLC, and the PDCP may decide, on per packet-to-packet basis, if the default path or the alternate path is to be used.

In some examples, there may be a configured maximum amount of data (e.g., in terms of number of packets or total number of bits) a given PDCP entity may transmit to the alternate RLC entity within a given configured time. Similar restrictions may be applied to the default RLC entity. There may be a configured maximum amount of data (e.g., in terms of number of packets or total number of bits) a given PDCP entity can have pending acknowledgement over the alternate RLC entity (or the default RLC entity).

In some examples, the PDCP may be configured with a certain prohibit timer for switching between the default and/or alternate RLC entities (e.g., no switching within less than x ms). In addition and/or instead of the prohibit timer, a data size amount could also be specified (e.g., no switching until n number of packets or z number of bits are transmitted via the newly chosen RLC entity).

In some examples, the PDCP may be configured with the maximum number of packets or total amount of data, and/or a maximum duration that it may push packets to the alternate path after the conditions to use the alternate RLC are fulfilled, and then it may revert to using the default RLC.

In some examples, some packet types (e.g., low priority packets, packets of low importance, packets having very high delay budget, etc. ,) may be configured to be sent only via the default RLC path only. In some examples, only some packet types (e.g., high priority packets, packets of high importance, packets having very low delay budget, etc.) may be configured to be sent only via the alternate RLC entity.

In some examples, only some packet types (e.g., high priority packets, packets of high importance, packets having very low delay budget, etc.) may be configured to be sent via the alternate RLC entity if other conditions are further fulfilled (e.g., congestion indication from the network, buffer level at the WTRU, either for that PDCP entity or all packets, etc.)

In some examples, all packets, regardless of their type and/or importance, may be sent over the alternate RLC entity if one or more of the other conditions discussed above and/or herein are fulfilled. There may be many alternate paths for a given PDCP entity (e.g., one RLC entity may be mapped to more than two PDCP entities).

The different RLC entities may be mapped to different MAC entities (e.g., RLC entity C may be mapped to a MAC entity associated with a different RU and/or DU as compared to RLC entities A or B).

In some examples, the WTRU may receive an indication (e.g., a MAC-CE) that activates and/or deactivates the alternate RLC entity for a given PDCP entity. For example, if it's a deactivation, then the PDCP entity may stop transmitting packets to that RLC entity (e.g., until a subsequent activation message is received). Additionally and/or alternatively, the deactivation and/or activation may have a time duration value associated with it (e.g., indicated within the MAC-CE, for instance, as index to a time duration value, and/or configured separately before the MAC-CE was sent, for instance, in a previous RRC configuration of the PDCP and/or RLC entities, specified in 3GPP standards, etc.), and the WTRU applies the activation and/or deactivation for that period. It should be noted that the activation and/or deactivation may only be affecting the behavior of the PDCP entity (e.g., other PDCP entities may keep using that alternate RLC entity, if there was a many-to-many mapping as discussed above). In some examples, the activation of the alternate RLC means that the WTRU will use the alternate RLC entity until a subsequent deactivation message may be received. In some examples, the activation of the alternate RLC may mean that the WTRU will consider the alternate RLC as the default RLC (e.g., until further deactivation message). In some examples, the activation of the alternate RLC may not mean that the PDCP entity will start using the alternate RLC entity immediately. For example, the other conditions discussed above and herein may need to be checked to determine to transmit the packets via the default and/or alternate RLC entity (e.g., on a packet-to-packet basis, periodically, etc.).

In some examples, the WTRU may receive an indication to deactivate the alternate RLC entity for more than one PDCP entity (e.g., in the case of many-to-many mapping). For example, a single message can be used to deactivate the alternate RLC entity for all PDCP entities.

It should be noted that the deactivation discussed above and herein may only be affecting the interface between the PDCP and/or RLC entities (e.g., whether the PDCP can push the packets to the RLC entity) and not the operation of the RLC transmit function (e.g., the transmission and/or processing of pending RLC packets will continue, even those that belong to the PDCP entity that just deactivated it path to the RLC entity).

The WTRU may monitor one or more conditions, possibly configured, that may control how much time the WTRU monitors for the reception of acknowledgments associated with data transmitted over a certain RLC to determine whether the alternate RLC is to be used or not (e.g., upon expiry of a timer, the WTRU may switch to transmit the next PDU-or retransmit the SDU-on a different RLC entity). If the time elapsed since the transmission on the default path, the WTRU may route next data transmissions, for example, with priority, importance above a threshold, data of a given QoS class, and/or data with remaining time less than a threshold-over the non-default path and/or the alternate RLC.

In some examples, a cross-layer indication within a protocol stack at the WTRU may be used to indicate statistics and/or KPIs related to performance of a given path (e.g. PER, BLER, max throughput, channel measurements, delay, round trip time (RTT), transmission latency, and/or HARQ operating point related performance). Based on one or more KPIs, the WTRU may select a path as function of the measured KPI being above or below a given configured threshold. The WTRU may select the path that maximizes or minimizes the set of applicable KPIs for the selected path. KPIs may be kept and measured over a measurement window that is configured. In one example, communication between RLC and PDCP may provide information to the PDCP about average RTT time for the packets sent via that path, and the WTRU may thus make a decision to route the packets via one path or the other based on the measured RTT and the requirements, possibly against a set of requirements for the packet being sent (e.g. the WTRU may not send a packet over path x if the RTT associated with the path is less the packet's delay budget plus a margin). This may be useful in the case of the RLC entities being mapped to different MAC entities (e.g. subsequently mapped to different Dus and/or RUs).

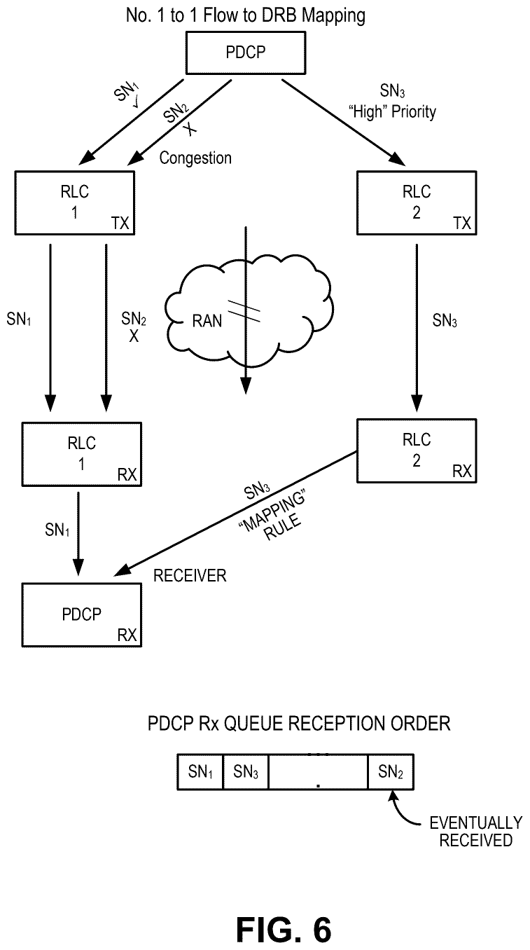

FIG. 6 illustrates an example PDCP to RLC entity mapping (non-DRB based). In some examples, from the perspective of the transmission side (e.g. uplink at the WTRU), the PDCP transmission entity and/or an SDAP entity may be configured with a plurality of associated RLC entities. A data flow may be associated with such plurality of RLC entities (e.g., rather than a semi-static data flow to DRB mapping). In this example, the same may be done by moving the PDCP function to an SDAP layer and/or a higher PDCP layer. In this example, the same may be done by moving the RLC functionality to an ARQ layer (e.g., at a higher MAC sublayer), and/or a lower PDCP layer (e.g. at DU and/or one that combines RLC and PDCP). Each RLC entity may be, for example, associated with a DU and/or an RU.

In some examples, the WTRU may be configured with a set of mapping rules to flexibly route data to one of the configured multiple RLC entities associated with the data flow. The mapping rules may include one or more of the following: a QoS class marking (e.g. from higher layers), a RAN QoS treatment profile (e.g., associated with a QoS class marking), packet priority, packet importance, packet delay budget and/or remaining time, the data type (e.g., systematic, SRB, AI/ML, sensing, dependent/multi-modal data, FEC data, etc.), whether an indication from the network is received for routing (e.g. indicating an RLC entity), whether one or more control plane event is met (e.g., on a given RLC entity, such as a mobility event condition, RLM/RLF, a beam failure, etc.), as a function of the transport layer protocol (e.g. whether QUIC is used and/or out of order is already done at transport layer), packet data volume, network energy saving (NES)/WTRU power saving state, and/or a data treatment flow marking which may represent data flow or PDU association (e.g., inter-flow dependency).

In some examples, the WTRU may transmit PDCP entity maps and may transmit a first data packet (e.g. SDU) on a first selected RLC entity. The WTRU may transmit PDCP entity maps and may transmit a second data packet (e.g. SDU) on a second RLC entity selected per the mapping rules, if one or more is met: whether congestion determined (e.g. by indication from the NW) on a given RLC entity, the transmission window stalled on one RLC entity, a NACK is determined for one or more previously transmitted SDU with a lower SN, transmission of X number of SNs is not acknowledged by the receiver and/or NACK'ed, any condition above relating to packet priority, and/or SN of the second packet being higher than the SN of the first packet.

In some examples, the transmit PDCP entity may append each packet with a data flow ID and/or a PDCP ID and a sequence number that may be used for assembly at the receiver. To avoid transmission window stalling, the PDCP transmission entity may assign the SN by transmission order. Such IDs may be included in PDCP headers and/or sub-headers and/or PDCP control PDUs. Additionally and/or alternatively, the ID may be included in the MAC header based on which the receiver MAC entity routes the traffic to proper PDCP entity. Integrity protection, ciphering, and/or count may be done on a per data flow ID basis (e.g., the data flow ID could be part of the COUNT, for instance, form at least part of 8 most significant bits (MSBs) of PDCP COUNT).

In some examples, from the perspective of the receiver side (e.g. downlink at the WTRU), the WTRU may receive PDCP entity and/or an SDAP entity, that may be configured with a plurality of associated RLC entities, corresponding to the RLC transmission entities. A data flow may be associated with such plurality of RLC entities (e.g., rather than a semi-static data flow to DRB mapping). The WTRU may receive PDCP entity re-assembles and re-orders received PDUs of the same with a data flow ID by order of SN. The receiver entity may additionally and/or alternatively deliver received packets out of order to higher layers for reordering at higher layers. The PDCP to RLC entity mapping (e.g., non-DRB based) may support avoiding transmission window stalling, allow a native design for out of order transmission, and/or flexible packet transmission without relying on a specific DRB.

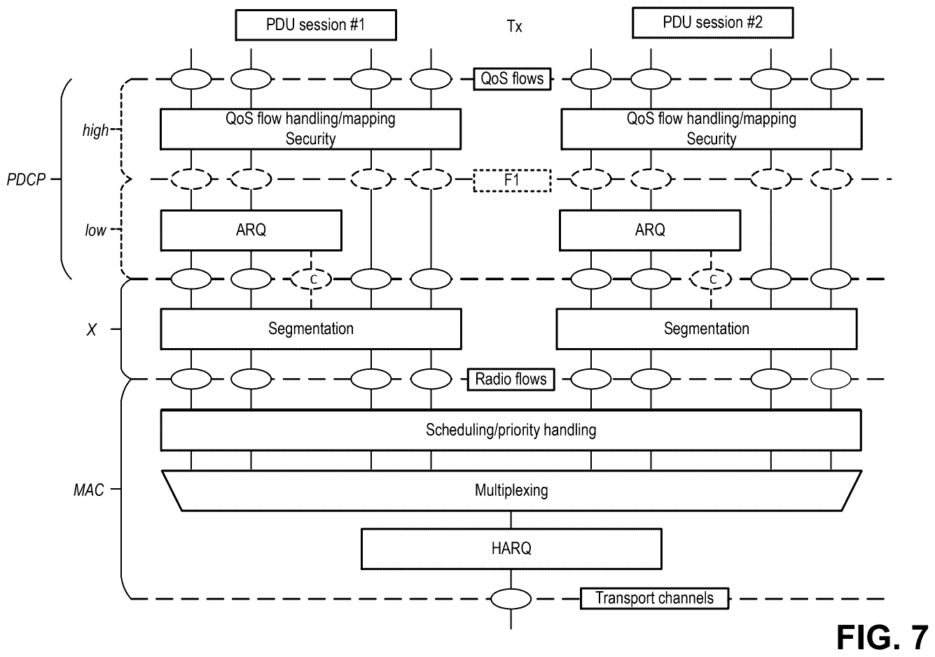

FIG. 7 is an example illustration of where the PDCP handles data flows and/or QoS flows and MAC schedules per data flow, from the transmission side, for instance, uplink at WTRU or downlink at NW node (e.g., 6G-NB). In some examples, from the perspective of the transmission side, PDCP Tx entity may receive SDUs from higher layers (e.g., data/QoS flow specifically). For example, there can be one PDCP entity per each PDU session/service. Additionally and/or alternatively, two or more PDCP entities per PDU session and/or service may be used if multiple NW entities are involved in the communication (e.g., two or more DUs (Distributed Units) or two or more CUs (Central Units) like in the dual connectivity). In some examples the PDCP entity may handle each data flow separately and assign each data flow a different COUNT and/or SN. In one example, the data flow ID is part of the COUNT calculation where the data flow ID may construct a part of the COUNT. For example, the COUNT may be 32 or 40 bits long and the data flow ID is part of the 8 MSBs of the COUNT while the least significant bits (LSBs) of the COUNT may define the SN for the SDU of the data flow (e.g., 18 LSBs). In some examples, PDCP protocol layer and/or an entity may be split into two parts (e.g., PDCP-high and PDCP-low as in FIG. 7) where some of the functionality in the PDCP Tx entity is handled by the PDCP-high and the remaining part by the PDCP-low. For example, PDCP-high may associate COUNT and/or SN for each SDU of a data flow, perform security (e.g., ciphering and/or integrity protection (IP)) on a data flow basis, perform header compression (like robust header compression (RoHC) or ethernet header compression (EHC)), associate a timer for each SDU (e.g., discard timer), create PDCP header for a SDU (including, for instance, SN, data flow ID, etc.). PDCP-high may also map certain data flows to ARQ functionality in the PDCP-low. For example, PDCP-low may perform ARQ functionality like performing re-transmissions, polling, etc. In one example, PDCP-high and PDCP-low may be implemented by a single entity also in the NW/6G-NB side and both reside in the CU and/or in the DU. In another example, PDCP-high may be deployed in the CU and PDCP-low may be deployed in the DU. In some examples, a NW interface may be exploited in between the PDCP-high and PDCP-low. For example, such interface could be F1-interface and/or any equivalent fronthaul interface exploited between CU and/or DU. In some examples, at the WTRU, the PDCP-high and PDCP-low may be implemented by a single entity (e.g., PDCP).

In some examples, the functionality of the X layer above in FIG. 7 may be implemented by the PDCP entity (e.g., PDCP-low) or may be a separate entity (e.g., like RLC) or may be implemented by the MAC entity. This layer and/or entity may also perform the buffering of the data from data flows before transmission. In some examples, the X layer maps data to MAC PDU based on the MAC scheduler decisions and may not add headers for X layer SDUs that may not be segmented. For instance, only the X layer SDUs that need to be eventually segmented into the MAC PDU, the X layer adds a segmentation header which may consist information like, segmentation info (whether the segment is first, middle or last segment of the SDU OR only whether the segment is the last segment of the SDU or not), sequence number used by the receiver to combine segments belonging to the same SDU, etc. In one example, the sequence number used for the segmenting may be the PDCP SN and/or subset thereof. Additionally and/or alternatively, the SN is a separate SN assigned by the X layer. In some examples, if the X layer functionality is not part of the PDCP entity (e.g., is implemented by an RLC entity or MAC entity for example), the X layer may provide information to the ARQ entity on what segments of data flow SDU(s) have been mapped to a lower layer PDU and/or MAC PDU.

In some examples, the MAC entity may schedule the transmission data on a per data flow basis (radio flows in the above figure) (e.g., MAC entity sees the data and/or QoS flows).

For example, the MAC entity at the WTRU may be configured with rules on how to schedule the data flows into a MAC PDU. In one example, the configuration may be on a per QoS flow basis, or additionally and/or alternatively, the MAC gets packet based information from the higher layers with respect to each SDU of a data flow or per data flow. For example, some information could consist of one or more of the following: a QoS class marking (e.g. from higher layers); a RAN QoS treatment profile (associated with a QoS class marking); packet priority; packet importance; packet delay budget or remaining time; the data type (e.g., systematic, SRB, AI/ML, sensing, dependent/multi-modal data, FEC data); PDU set related information; transport layer protocol (e.g. whether QUIC is used and/or out of order is already done at transport layer); packet data volume; NES and/or WTRU power saving state; and/or a data treatment flow marking which may represent data flow or PDU association (e.g., inter-flow dependency).

In some examples, the MAC entity may add a MAC subheader for each MAC SDU. The subheader may consist of information of the SDU for the receiver MAC entity. For example, the subheader may consist of PDCP entity ID and/or PDU session ID (e.g., based on which the receiver MAC entity knows the PDCP entity where to map the data); whether the SDU is segmented by the X layer (e.g., by PDCP or RLC entity) based on which the receiver MAC entity may map the SDU to the X layer processing or may indicate to X layer whether the SDU is segmented so that the proper header processing can be performed; SDU length; etc.

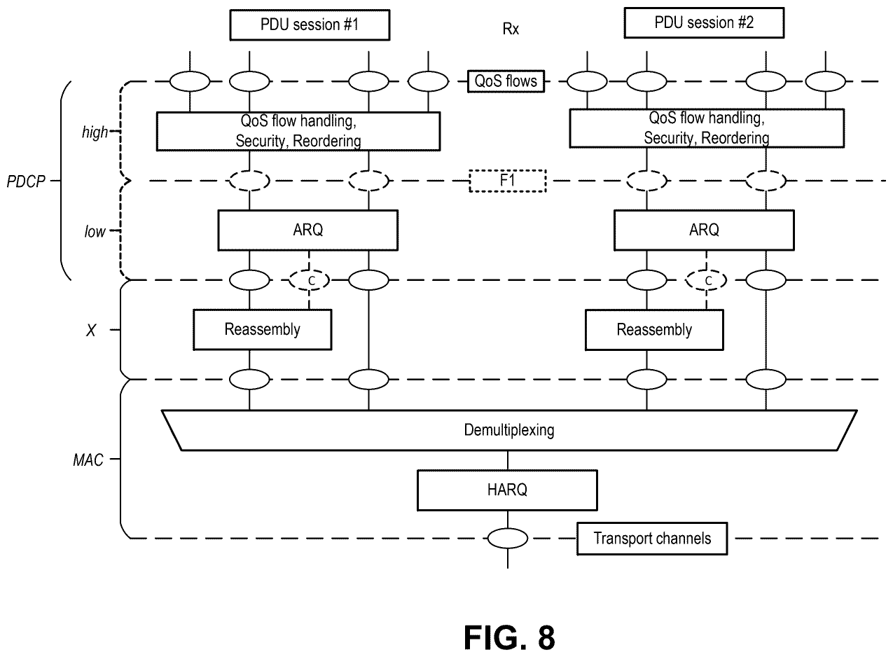

FIG. 8 is an example illustration of where the PDCP handles data flows and/or QoS flows and MAC schedules per data flow, from the receiver side, for instance, downlink at WTRU or uplink at NW node (e.g., 6G-NB). In some examples, from the perspective of the receiver side, the PDCP transmission entity receives SDUs from higher layers (e.g., data). For example, the receiver MAC entity may receive MAC PDUs from lower layers and demultiplexes the data into MAC SDUs. The receiver MAC entity may determine from the MAC SDU subheader to which PDCP entity the SDU is to be forwarded. The receiver MAC entity may determine from the MAC SDU subheader whether the MAC SDU is a segmented higher layer SDU based on which the Rx MAC entity may forward the SDU to X layer for reassembly (e.g., segmented) and/or directly to PDCP processing (e.g., not segmented).

In some examples, the X layer in the receiver may similarly be implemented by the MAC entity, by the PDCP entity and/or may be a separate layer and/or entity (e.g., like RLC). MAC SDUs that are not segmented by the transmission X layer may be directly passed to the PDCP entity through a logical interface. In some examples, if the X layer is implemented by RLC, the RLC Transparent Mode (TM) may be used for the logical interface. MAC SDUs that are segmented by the transmission X layer may be passed to the X layer processing. For example, The X layer (e.g., MAC, RLC and/or PDCP) may buffer the segment and/or performs reassembly of multiple segments to form a higher layer SDU. The X layer (e.g., if not part of the PDCP functionality) may provide information about the received segments to the ARQ functionality in the PDCP entity. The X layer may pass the reassembled SDUs to PDCP entity.

In some examples, the PDCP entity may receive SDUs from the X layer and/or directly from the MAC layer and performs functions/operations per data flow. For example, data flow that does not require ARQ and/or is not configured with ARQ may be deciphered and/or put on the reordering buffer (e.g., if reordering required) or additionally and/or alternatively, directly passed to higher layers. For example, data flow that requires ARQ may be deciphered and/or placed on the reordering buffer (e.g., if reordering required) and/or directly passed to higher layers and SN is logged in the ARQ functionality.

For example, ARQ functionality may be performed on a per data flow basis where the status reports by the receiver PDCP entity may be transmitted on a per data flow basis or then combine one or more data flows into a single status report. For instance, the status report may consist of data flow ID and highest acknowledgement SN for the given data flow ID and one or more negative acknowledgement SN(s) for the given data flow ID. After this, information about another data flow ID may be composed into the same status report. In some examples, status report may be composed on a priority order of data flows. For instance, the most important data flow ID and its information may be placed first in the status report so that if the information needs to be truncated (e.g., not enough big grant to transmit the whole status report), the highest priority data flow(s) gets reported at least.

The ARQ functionality may be implemented by the PDCP low so that status reporting may be performed without fronthaul interface latency. In some examples, the ARQ functionality can be placed in CU and/or DU at the NW based on NW implementation. In some examples, fine granularity scheduling (data flow basis) may allow prioritizing data on a per packet and/or flow basis achieving better QoE. Data flow specific handling in the radio UP stack may avoid any head of line blocking issues between different flows.

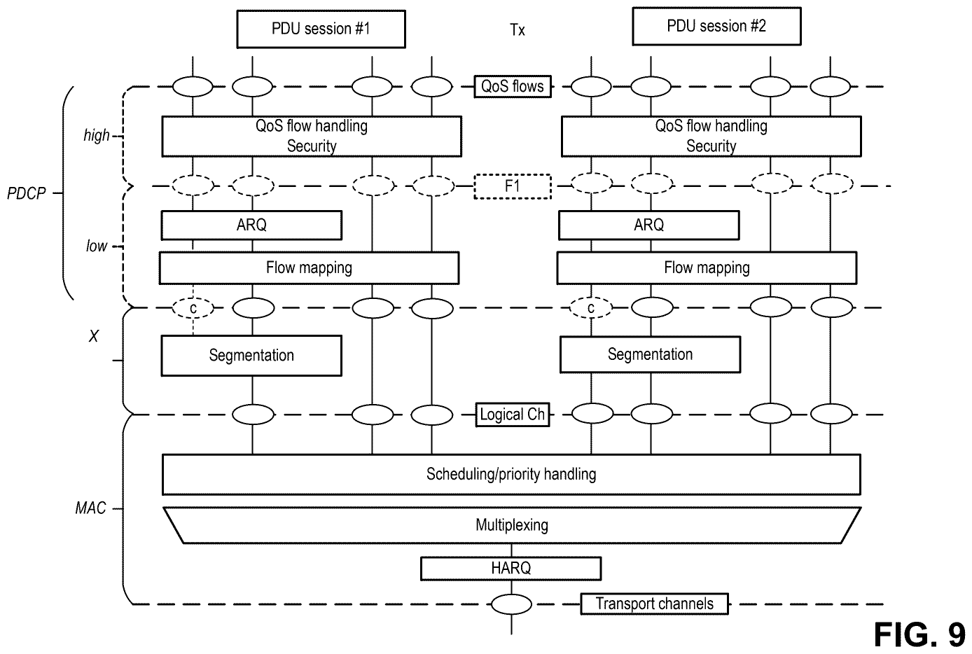

FIG. 9 is an example illustration of where the PDCP handles data flows and/or QoS flows and MAC schedules per logical channel, from the transmission side, for instance, uplink at the WTRU or downlink at NW node (e.g., 6G-NB). FIG. 9 is equivalent to the examples related to FIGS. 7 and 8 in terms of functionality, however, PDCP entity may implement additional functionality in mapping the data flows into logical channels (e.g., flow mapping box in FIG. 9). In some examples, from the perspective of the transmission side, In an example, PDCP entity (e.g., like PDCP low in the NW) implements a flow mapping functionality that based on rules and packet characteristics map data to logical channels. For example, the mapping rules could consist of one or more of: a QoS class marking (e.g. from higher layers); a RAN QoS treatment profile (associated with a QoS class marking); packet priority; packet importance; packet delay budget or remaining time; the data type (systematic, SRB, AI/ML, sensing, dependent/multi-modal data, FEC data); PDU set related information; transport layer protocol (e.g. whether QUIC is used/out of order is already done at transport layer); packet data volume; NES/WTRU power saving state; and/or a data treatment flow marking which may represent data flow or PDU association (e.g., inter-flow dependency). The logical channels where the flow mapping functionality maps the data from the data flows may have different characteristics and/or may be characterized terms of one or more of the following: priority; prioritized bit rate; bucket size Duration; segmentation possibility or no segmentation at all; Packet Delay Budget (PDB) or remaining time; data flow IDs allowed to be mapped; A data treatment flow marking which may represent data flow or PDU association (e.g., inter-flow dependency)

In some examples, a MAC layer then schedules the logical channels based on the characteristics of the logical channels and/or the amount of data they have. Logical channel ID may need to be indicated in the MAC SDU subheader for the receiver MAC entity being able to forward the data to a proper PDCP entity. Additionally and/or alternatively, similar approach as in the previous example is used where the MAC subheader of an SDU only indicates the PDCP entity ID/PDU session ID, and other information of the SDU (e.g., like whether it is segmented, or not). The PDCP entity may handle the flow mapping as discussed in the previous example, above and herein.

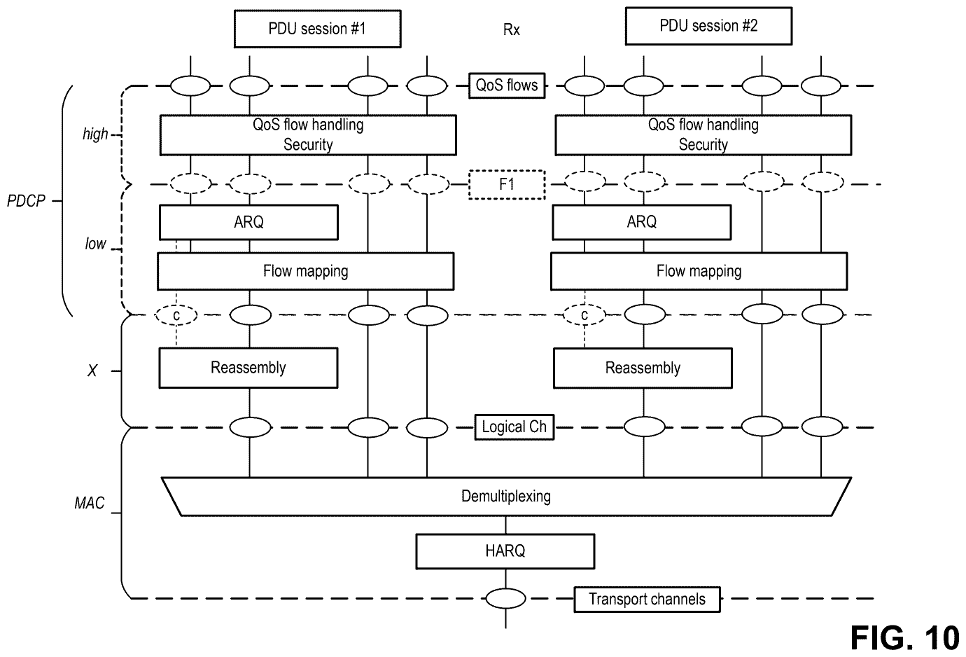

FIG. 10 is an example illustration of where the PDCP handles data flows and/or QoS flows and MAC schedules per logical flow, from the receiver side, for instance, downlink at WTRU or uplink at NW node (e.g., 6G-NB). In some examples, benefits may include less granular scheduling required by MAC entity which may be easier to be configured for a WTRU and less complex to be performed and/or implemented.

SDAP and/or QoS treatment in RAN layer may be implemented. In some examples, a flexible user plane architecture may aim to support a variety of data types and/or applications. There may be dependencies to manage in the QoS and/or QoE framework between not just data of the same service, which make QoS vary over time depending on other flows and/or data. For example, there can be inter-flow UP dependencies (e.g., a multi-modal XR service, an XR service that has AR, and/or a subset of the data such as AR objects, metadata for scene description and/or updates thereof), dependency between user plane data and system data (e.g., sensing of real objects plus position to help anchoring the AR objects coherently with the real world), and/or dependency between UP data and CP data (e.g., in case of mobility triggers that initiates from sensing activity that is associated to mobility). Therefore, QoS may be needed to be treated differently (e.g. temporally) for some packets of a data stream.

Assuming DRBs are removed and a QoS layer is kept, QoS flow identity (QFI) and/or QoS class marking may be assigned on a per packet-basis. An L2 interface may enable elastic QoE level varying (e.g. somewhere between the min data rate/GBR and max data rate), while QoS is met. QoE must meet a minimum requirement. For example, the WTRU may start transmission of data with a given QoE level that is higher, then as WTRU moves out of coverage, experiences cell congestion, and/or when data rate drops, the WTRU may then reduce the QoE level or reduce the number of data packet sets that are transmitted (e.g. if there are multiple/multi-modal streams, the WTRU may drop one stream that is not necessary to meet the min QoE level while still maintaining the QoS).

Elasticity of meeting QoS requirement means that the QoE level may change (e.g. some where between the min data rate/GBR and max data rate), though QoS is met. QoE may meet a minimum requirement. For example, the WTRU may start transmission of data with a given QoE level that is higher, then as WTRU moves out of coverage, experiences cell congestion, or when data rate drops, the WTRU may then reduce the QoE level and/or reduce the number of data packet sets that are transmitted (e.g. if there are multiple/multi-modal streams, the WTRU may drop one stream that is not necessary to meet the minimum QoE level while still maintaining the QoS). Such may be done transparent to RAN (e.g. realized by NW configuration). In some examples, the application itself may adjust the rate of the packet set, and in such case the WTRU does not change the underlying QoE level (e.g. when the video rate is decreased by the application). This may mean that the WTRU may or may not be aware of the application layer (e.g., no awareness in the first case, but awareness in the second way).

In some examples, an L2 interface may enable one or more of the following, wherein QoE is a measurement of how a user perceives a service, while QoS measures key network service performance parameters that can be observed and measured (e.g. latency, jitter, data rate such as non-GBR, GBR, delay-critical GBR, maximum data burst, etc.): elastic QoS level varying, while a QoE level is met. For example: the WTRU may be configured with one or more QoS levels for a QoE level; the WTRU autonomously or upon receiving network command, switch QoS level as a function of one or more of channel condition thresholds, indication from application for whether QoE level is met or not met; the WTRU may apply QoS level switch on L2 interface, on per-PDU basis or on per-PDU-set basis (e.g., the WTRU may selectively apply QoS level on per-packet basis or on per-packet-set basis). For example, at any given point in time, buffering frequency and smooth playback at the application layer of a scalable video streaming service may have dependency on the current minimum data rate the network can sustain. If channel condition degrades (e.g., below a threshold) and/or the WTRU receives an indication from the application that QoE level is not being met, WTRU may switch from a first data rate (high data rate) that allows transmission of packet from both base layer and enhancement layer to a second data rate (low data rate) that allows only transmission of base layer packets to minimize buffering and provide smooth playback consistently with the QoE level.

L2 interface may enable elastic L2 configuration (protocol behavior) varying and resource level varying, while a QoE level or QoS level is met, for example: the WTRU may be configured with two or more L2 interface configurations (possibly with different resource level or type) in support of one or more QoS levels or one or more QoE levels. The WTRU may autonomously and/or upon receiving network command, switch L2 interface configuration as a function of one or more of channel condition thresholds, indication from application for whether QoE level is met or not met. The WTRU may autonomously and/or upon receiving network command, switch L2 interface configuration based on SDU/PDU information markings (e.g., realtime transport protocol (RTP) header extension (HE) of QoE level, and/or RTP HE of QoE level state). The WTRU may apply L2 interface configuration switch on per-PDU basis or on per-PDU-set basis. For example, at any given point in time, buffering frequency and smooth playback at the application layer of a scalable video streaming service may have dependency on the current minimum data rate the network can sustain. If channel condition degrades (below a threshold), and/or WTRU receive an indication from the application that QoE level is not being met, WTRU may switch from a first L2 configuration/resource level or type to a second L2 configuration/resource level or type in order to maintain the current QoE and/or QoS level. L2 interface may enable elastic QoS level varying, for elastic QoE level varying.

In some examples, the SDAP may be removed, QFI may be moved to PDCP, and this would reduce headers if SDAP is removed. However, SDAP header is not cyphered. Ciphering may be done as late as possible to allow WTRU to do last minute changes (e.g., last minute processing, for instance, for delay critical). In some examples, the QoS layer may alternatively be kept with the aim of controlling QoS treatment and QoE per packet, rather than semi-statically mapping a QoS flow to a DRB.

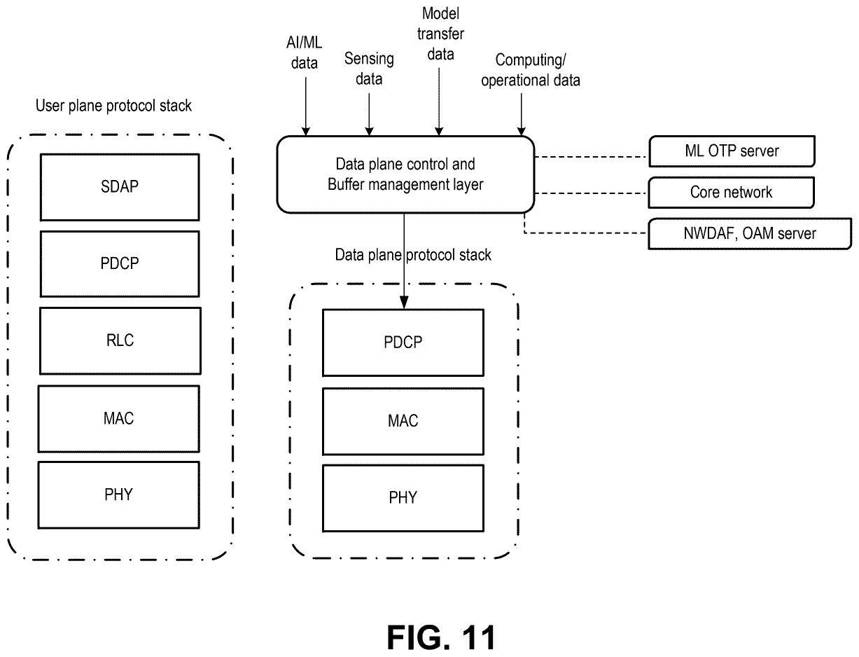

Data plane and user plane may be implemented. FIG. 11 is an example illustration of a data plane protocol stack model. A data plane protocol stack may have a subset of the user plane sub-layers/protocols and/or reduced functionality sublayer protocols.

In some examples, the WTRU data plane RLC and/or higher MAC sub-layer may (e.g., whether to support or not can be configured) include the following. The WTRU data plane RLC and/or higher MAC sub-layer may support only UM or TM (no AM), possibly dependent on the data type; not support segmentation (e.g. an SDU is either transmitted in whole or not at all); conditionally support segmentation (e.g. dependent on the collected data type); support concatenation by the data plane but not the user plane; concatenate as many SDUs as possible to reduce header overhead (e.g. for ML data); avoid adding headers as much as possible to reduce overhead (e.g. similar to RLC TM mode); not support ARQ retransmissions, possibly depended on the collected data type. For some ML data, data can be transmitted once from PDCP/RLC perspective and rely on lower layers for reliability. Loss of data can be more tolerant for certain collected data types; Not support RLC polling and/or status reports, possibly dependent on data type or the data plane DRB configuration; and/or not support transmission windows, unless segmentation occurs.

In some examples, the data plane PDCP layer may (e.g. whether to support or not can be configured) include the following. The data plane PDCP layer may not support in-order delivery, possibly dependent on the data type. The data plane PDCP entity may thus not support transmission windows, at least for data packets that don't require it. The transmit window may be limited to the other data types.

The data plane PDCP layer may use the PDCP buffer management function to manage how long the WTRU keeps collected data and when to make it available for transmission/buffered at lower layers. Such function can also be maintained in SDAP/QoS RAN layer. Complementary conditional discard based on collected data relevance (PDCP discard timer is typically set based on time needed by lower layers to deliver the data reliability), the WTRU may keep the data until an indication is received from the NW to flush stored data, e.g. possibly for a given data type or LCH/bearer. A new data relevance discard timer may be introduced to discard stale collected data that may not be relevant anymore or not needed by the data collection server. Data packets may be discarded if fresher data (e.g. of the same type) is collected/buffered at the WTRU, possibly dependent on data type (sensing data, ML data type etc.). Support more varied discard, e.g. longer or shorter discard timers can be configured to discard collected data. Discard timer values may be dependent on the data type of the data collection or the termination point (e.g. CN node and/or an OTP server) for the collected data and/or the LCH configuration.

The data plane PDCP layer may use data routing based on DRB or non-DRB, (e.g. per information disclosed above and herein), possibly dependent on data type. The data plane PDCP layer may not support polling and/or status reports, possibly dependent on data type or the data plane DRB configuration. The data plane PDCP layer may support or not support data routing, split bearers, dual connectivity, possibly only for some data types. The data plane PDCP layer may selectively support integrity protection, possibly dependent on data type. The data plane PDCP layer may not support retransmission and/or reordering, possibly dependent on data type. The data plane PDCP layer may not support sequencing, possibly dependent on the data type (e.g. for collected data types that are self-identifiable). Otherwise, it may add sequence numbers to a subset of data types or a subset of RBs (e.g. ones configured to do so). The data plane PDCP layer may support a single PDCP entity per data type (e.g., instead of per DRB), per data flow, per QoS flow, or per configuration. The data plane PDCP layer may not support or not ROHC. The data plane PDCP layer may not support or not integrity protection.

In some examples, the WTRU data plane MAC layer may support (e.g., whether to support or not can be configured): Temporal importance and prioritization of data plane data. This means some data may be of higher priority at time instance t1 than at instance t2 (t2>t1), or vice versa. This can affect LCP and buffer status reporting. The WTRU data plane MAC layer may support separate scheduler purposed reporting control elements for data plane data (e.g. BSR, PHR) and/or control elements that are combined with user plane data. The WTRU data plane MAC layer may support selectively support integrity protection, possibly dependent on data type. The WTRU data plane MAC layer may support a simplified and/or differentiated LCP/traffic shaping procedure for multiplexing data from the data plane (e.g. as discussed above and herein). The simplified LCP may work in conjunction with the user plane LCP. The WTRU data plane MAC layer may support a differentiated BSR/SR procedure, where the WTRU may trigger/report SR/BSR separately and/or in conjunction with user plane data buffered at the WTRU. The WTRU data plane MAC layer may support conditionally support HARQ (e.g., or not support it), dependent on the data type or the data plane LCH configuration. The WTRU data plane MAC layer may support intra-WTRU prioritization amongst user plane and data plane data, data plane control elements and user plane control elements, data plane data and user plane control elements, and/or data plane control elements and user plane data. The WTRU data plane MAC layer may support LCID allocation to differentiate data plane control elements and data.

The data plane may or may not support and SDAP layer, or possibly support a simplified data plane SDAP layer which may, for example, map QoS flows to DRBs, possibly dependent on data type; mark data with QoS class markers as discussed above and herein (e.g. in headers or part of GTP-U headers and pass them down to lower layers for QoS treatment in RAN); SDAP may be supported for a subset of data in the data plane. Data packets for which SDAP is not need can have operate in an SDAP TM mode, e.g. where no headers are added or a simple header with a Boolean flag is used to indicate TM mode is associated with such packet.

In some examples, the data plane may support a new DCBM layer or function to control and define formatting and identification of DP data messages (e.g. to differentiate and identify data from AI/ML sources, sensing, measurements, model transfer, computing services, and/or operational services), and control data availability and transfer to the RAN data plane protocol stack. The DCBM may be considered as layer within the data plane or a function that is embedded in each user plane layer (vertically represented in each layer), for example, to control data availability and transmission.

The DCBM may identify in a header the data type, termination point (e.g. NWDAF entity, operations, administration and maintenance (OAM) server, and/or ML one time password (OTP) server) for which the data is applicable for, and/or QoS related markers (e.g. a QoS class). The DCBM may encapsulate system level information, e.g. used for ML and/or model transfer.

The DCBM layer may also provide configurations and control for DP data. A subset of RRC functionality may also be assumed or configured for data plane data/data flows. For example, a subset of RRC user plane radio bearer configurations may be assumed or configured for the data plane. A new type of DRB configuration may be assumed and/or configured for DP data flows. A subset of RRC states (e.g. connected mode, inactive mode) may be assumed for the data plane. RRC transitions between states may be barred or limited. For example, the WTRU may not trigger RRC resume requests and/or RRC re-establishment requests due to DP data arrival or failure due to DP data transmission. For example, control messages may be provided and may be marked (e.g. in a header), possibly as a function of the termination point of the data plane data type.

In some examples, the DCBM layer may provide control for when the WTRU provides DP data to RAN data plane protocol layers, when the WTRU reports buffered data that is not yet provided to DP layers, when the WTRU reports data that is provided to DP layers (e.g. in a BSR/SR), and/or when the WTRU can multiplex and/or transmit DP data on an uplink grant. Detail on such buffer management function is discussed below.

In some examples, a data plane data flow can be resembled by a user plane data flow bearer (e.g. a DRB), a control plane bearer (e.g. an SRB or a specific type of SRB), or a logical buffer/container that handles data of a given data plane type. Herein, DP data may be used to refer to data configured from a specific data type, bearer, data flow, and/or logical buffer.

In some examples, the DCBM may be a layer within a protocol stack (e.g. data plane or user plane protocol stack), a function within some or all of user plane layers (e.g. a function within PDCP, SDAP, MAC etc, vertically represented in each layer), or a control function that controls the data propagation and processing of data in RAN (e.g. sitting above user plane layers).

In some examples, the DCBM layer may provide support for a packet classification (e.g., filtering) function to enable differentiated treatment of packets in the data plane, e.g. different data types may require different treatments. The WTRU may classify packets in data plane based on for example data type. The packet classification, or both the packet classification and the packet marking function may be part of PDCP. Additionally and/or alternatively, the packet classification function may be placed in SDAP (e.g., as part the data plane). Additionally and/or alternatively, a new packet classification protocol layer may be part of the data plane protocol stack (e.g. the DCBM). The protocol layer may also perform packet marking. The WTRU may be configured with one or more QoS Flow IDs for packet marking in data plane. Packet classification may be performed per the methods described herein.

In some examples, a buffer management function may control for reporting data plane data (e.g., BSR) and for when to transmit data plane data, including one or more of the following. For example, when to generate data plane data and/or when to make the data available for transmission at lower layer; how much to buffer and how to manage buffer; NW can request per bearer how much data you have (e.g., in a BSR); separate triggers for BSR than user plane; data at WTRU buffer can be conditionally available in BSR reporting; overriding of collected data (e.g., circular buffer)

In some examples, buffer management may postpone the transmission of certain collected data at a later time/date, whether to keep or discard data, and whether to make data available to lower layers. For an established data plane bearer/LCH, the WTRU may be configured with a maximum data storage size and a maximum time in storage period, both of which may be dependent on the WTRU capability. Beyond this maximum timer in buffer has elapsed, WTRU can trigger a BSR for it. The NW can then tell WTRU to continue or discard it (e.g. based on a sliding discard window). The NW can decide for the WTRU when to transmit the ML data.

Time based maintenance of collected data in buffer to manage how long the WTRU keeps collected data. In some examples, the WTRU may be configured with a storage period, possibly configured per LCH/RB (e.g., or in total for all the LCHs/RBs) or dependent on the WTRU capability. WTRU may be configured to start the storage period timer upon the start of the data collection, upon reception of an indication from the network (e.g. in a DCI or MAC-CE), upon logging the first data sample, upon the transmission of data sample to the PDCP, upon collecting a certain number of samples or amount of data (e.g., in bits), or upon logging the last data sample, etc. (e.g. upon data collection/arrival at PDCP). The storage timer configuration may be for the whole data collection (e.g., it may be left up to WTRU to allocate the max storage among the different data collection processes/bearers).

Upon expiry of the storage period timer, the WTRU may flush/discard the stored data (or configured size of the oldest data units) and/or replace it with new collected data of the same data type. The discarded data may be the least important/least priority data from the buffer, and/or the data that has been the longest in the buffer (e.g. with the least storage period value).

In one example, WTRU starts a storage period timer, for instance, one timer for a certain data collection process/bearer, separate timers for each collected data unit (e.g. the value of the timer may be dependent on a data type, LCH/RB, and/or based on data importance/QoS class); where: the WTRU may start the timer based on one or more of the following condition(s): when the data collection process is initiated (e.g., by explicit signal from the network, based on reception of command from application layers, etc.); when the first data sample is logged/collected; when the first data sample is transmitted; when the last data sample is logged/collected (e.g., the last sample that will make the buffer that is available for the concerned data collection bearer/process); and/or when a certain amount of data is logged (e.g., in number of samples, in number of bits, etc.).

Upon expiry of the storage period timer, the WTRU may be configured to perform one or more of the following: the WTRU may discard the associated SDU (e.g., if the timer is associated with a data unit); the WTRU may discard the whole collected data associated with the storage timer (e.g., if the timer is configured per data collection process/bearer); the WTRU may discard some of the collected data to make room for new data; and/or the WTRU may initiate the transmission of some of the collected data.

Memory constraint-based maintenance/discard of collected data in buffer may be implemented. In some examples, the WTRU may be configured with a max stored data volume, possibly configured per LCH/RB (or in total for all the LCHs/RBs) and/or dependent on the WTRU capability. The data volume configuration can be for the whole data collection (e.g., it may be left up to WTRU to allocate the max storage among the different data collection processes/bearers).

Once the WTRU has collected a max stored data volume, the WTRU may flush/discard the stored data (e.g., or configured size of the oldest data units) or replace it with new collected data of the same data type.

In one example, WTRU increments the amount of stored data volume by the amount of collection data that has arrived. If the amount stored data volume is larger than a threshold, the WTRU may flush/discard X bits/units of the fist stored data in this FIFO buffer, where X is configured and/or equal to the amount of data arrival to the LCH's buffer. That is, data buffer may be used in a circular fashion where older entries are removed to make room for newer data. In some examples, only data samples/units that have their discard timer expires can be deleted. In some examples, data samples/units that have their discard timer still running may be deleted. In some examples, only data samples/units that are of a certain QoS classification (as discussed above and herein) may be deleted. For example, only data of priority/importance less than a threshold may be deleted.

In some examples, the value of the stored data volume may be maintained by implementing a counter at the WTRU, and may be dependent on a data type, LCH/RB, and/or based on data importance/QoS class (e.g. where the WTRU maintains a counter per data type, per data importance, per QoS class, or per LCH/RB, etc.).

The WTRU may be configured to pause a given data collection process when the buffer associated with that data collection is full and it was not able to send the collected data to make room for new data (e.g., instead of discarding it), possibly conditioned on data type, DP LCH/RB, or QoS classification. The WTRU may be configured with a prohibit timer for this deletion. For example, the WTRU starts this timer upon the buffer becoming full, pauses the data collection process, and upon the timer expiry, resumes the data collection process, and will start discarding of older data to make room for the new data. If the data volume decreases even before the timer expiry (e.g., WTRU was able to send some of the DP data), the WTRU may stop the timer and resume the data collection process. The WTRU may remove data from one buffer associated with a given data type, LCH, or QoS class to make room for data of another type/LCH/QoS class that is more important, e.g. if the WTRU's DP buffer size is limited (e.g. the memory allocated for data collection across all LCHs/data types/QoS classes).

Event-based maintenance/discard of collected data may be implemented. In some examples, the WTRU may be configured to pause a given data collection process and/or discard the collected data based on one or more of the following: an indication from the network. Specifically, the WTRU may receive an implicit/explicit indication from the network to pause a given data collection and/or discard the collected data. The WTRU may receive further indication from the network to start/resume the data collection.

The WTRU may be configured to pause a given data collection process and/or discard the collected data based on the availability of data from user plane. In one example, the WTRU may pause a data collection and/or discard the collected data if the buffered data in the user plane, possibly associated with a set of DRBs/LCHs (e.g., a set of configured DRBs/LCHs such as the set of high-priority DRBs/LCHs, the set of DRBs/LCHs having higher priority than the data in the data plane), is greater than a configured threshold.

The WTRU may be configured to pause a given data collection process and/or discard the collected data based on downlink channel measurement. For example, the WTRU may pause the data collection and/or discard the collected data if the L3 RSRP is smaller than a configured threshold.

The WTRU may be configured to pause a given data collection process and/or discard the collected data based on link/beam failure. For example, upon RLF and/or BF is declared, the WTRU may pause the data collection and/or discard the collected data.

The WTRU may be configured to pause a given data collection process and/or discard the collected data based on the WTRU CPU load or processing state. For example, the WTRU may pause the data collection and/or discard the collected data if the WTRU transits to one or more configured CPU load or processing state (e.g., the high CPU load state, an intensive processing state). The WTRU may also trigger indication of its CPU load and/or processing state to the network.

Time/memory-based transmission of collected data in buffer may be implemented. In some examples, The WTRU may be configured to transmit the collected data to make room for further data collection, instead of discarding the data. To expediate the transmission of the collected data, the data plane may be temporarily treated with the same level of priority (e.g., in terms of scheduling) as the user plane data or even at a higher priority (e.g., for a given time duration, until the volume of the collected data is lower than a certain threshold, etc.), where such priority upgrade may be limited to a number of data units or bits that is needed to collect more data or by the amount of data plane data that has arrived.

Conditional availability and reporting of DP data (e.g. at PDCP/MAC) may be implemented. In some examples, the buffer management function may control when to make DP data available for reporting and/or transmission at user plane protocol layers.

For example, the buffer management function may control the availability of DP data may be controlled by schedule. The WTRU may postpone the reporting of certain collected data at a later time/date (timer based). For example, DP data can be made available to lower layers and/or reported a at a later time as a function of the current time in the day and or related to reception of an indication from the network to make the data available. Making data available to lower layers may correspond to an SDAP entity pushing data to lower layers (e.g. PDCP) only once the condition is met; or a PDCP entity making data available to a MAC layer only once the condition is met (e.g. where otherwise the MAC layer does not consider the data as buffered data available for reporting/transmission). In another example, postponing reporting/making data available to lower layers could be depending on the amount of other user plane data that is currently pending to be transmitted, congestion level of the network, etc.

For example, the buffer management function may control the availability of DP data may be controlled by whether one or more condition is met. DP data may be conditionally available to lower DP layers if one or more condition is met. buffered data at WTRU buffer can be conditionally available in BSR reporting; data reported if condition(s) is met, for instance, as a function of buffered user plane data, allowing signaling received from NW etc. A condition may include one or more of the following: buffered user plane data is of priority is less than a threshold; buffered user plane data volume is less than a threshold; buffered data plane volume is greater than buffered user plane data volume plus or minus a configured margin; priority of buffered data plane volume is greater than priority of buffered user plane data volume plus or minus a configured margin; buffered DP data volume is larger or lower than a threshold, e.g., based on the buffer filling level at higher layers (e.g. in DCBM); DL signaling is received from the network polling/requesting for a DP BSR; the storage period timer has expired or the remaining time before expiry is less than a threshold; the amount stored data volume is larger than a threshold (e.g. max stored data volume); load/NW congestion conditions. The WTRU may report DP data if congestion is not determined/detected, whereby the WTRU may determine the congestion level from NW signaling (e.g. broadcast or dedicated-MAC or DCI-signaling); determined NES state. The WTRU may report DP data if NW is not determined to be a network energy saving, whereby the WTRU may determine the NES state from NW signaling (e.g. broadcast or dedicated—MAC or DCI—signaling) or from the periodicity of broadcasted common signals/channels; WTRU power saving state. The WTRU may report DP data while C-discontinuous reception (DRX) is not activated, during the active period of C-DRX or cell discontinuous transmit (DTX), or during configured periods that occur periodically; WTRU CPU load or processing state. The WTRU may report/buffer DP data only in a subset of WTRU states (e.g. while the WTRU is not overheating, available memory is greater than a threshold, or CPU consumption is less than a threshold); time of the day condition (e.g. only during certain time window). WTRU may keep a time stamp along with collected data SDUs. The WTRU may receive signaling from the NW requesting to report/transmit DP data that is collected within x ms prior to the reception of the signaling or within a time window that is indicated part of the signaling; A data collection reporting request from application layer (e.g., if the collected data is to be sent to an application server outside the operator's network); and/or a measured channel condition/quality metric being larger or lower than a configured threshold.

Reporting of buffered DP data not yet made available to DP layers may be implemented. In some examples, data available at the WTRU (e.g. stored but not provided to DP lower layers) may be reported in a not yet available data status report, herein referred to a memory status report (MSR), which can report the amount of data that is in the WTRU's memory but not yet made available to lower layers in the DP for transmission and/or reporting (e.g. in a regular BSR).

For example, the format of the not yet available data status report (NA-DSR) may be as follows. The MSR can be transmitted in a MAC-CE or WTRU assistance information. The MSR may have multiple format types (e.g. long, short, padding, truncated). The long format may include the amount of bits in the WTRU memory e.g. memory status (MS), for more than one MS, where each MS is reported per data type, per DP data flow, per group of DP data flows or per logical container, or per group of logical contains for storing collection data. The short format may include a limited number of MSs (e.g. one or two). The padding/truncated format may include a limited number of MSs, where the number is dependent on the remaining space in the grant (e.g. the number of padding bits).

For example, triggers of the MSR may be as follows. An MS may be triggered if one or more of the conditions listed herein (e.g. under the section of the specification concerning conditional availability and reporting of DP data) is met. In one example, the WTRU may be about to run out of memory to collect more data or is about to discard collected data due to the limited memory size available, which may in turn trigger the transmission of an MSR (e.g. MS (bits) being above a threshold, MS(bits) for all logical containers/LCHs/LCGs is above a threshold, remaining time to discard is less than a threshold, etc.). An MSR may or may not trigger an SR, possibly dependent on the trigger condition. For example, an SR can be triggered if the data is about to be discarded (e.g. due to memory limitation or a circular buffer).

For example, cancellation conditions of an MSR may be as follows. An MSR can be considered as pending until it is cancelled. The MSR can be cancelled upon transmission of the MSR or multiplexing it in a grant, upon receiving an ack to a transmission containing an MSR, upon discarding data that is reported part of the MSR, upon transmitting a BSR at lower layers which reports data that is also part of the MSR computation, etc. The WTRU may trigger another MSR if the cancelled MSR does not report all MSs that are part of the MSR.

The MSR may be reported and computed in the DCBM layer, the PDCP layer (e.g. based on cross layer indications), or a combination of both.

Conditional availability of data for transmission (e.g. at MAC) may be implemented. For example, scheduling may be as follows: postpone the transmission of certain collected data at a later time/date. Data can be transmitted (e.g. in LCP) only within a time range.

For example, conditioned may be as follows: data can be transmitted (e.g. in LCP) if condition(s) is met, DP data may be conditionally available to lower DP layers for transmission if one or more condition is met. A condition may include one or more of the following: buffered user plane data is of priority is less than a threshold; buffered user plane data volume is less than a threshold; buffered data plane volume is greater than buffered user plane data volume plus or minus a configured margin; priority of buffered data plane volume is greater than priority of buffered user plane data volume plus or minus a configured margin; buffered DP data volume is larger or lower than a threshold, for instance, based on the buffer filling level at higher layers (e.g. in DCBM); DL signaling is received from the network allowing DP data to be transmitted. The UE may start a timer after the reception of such signaling, and only transmit DP data while the timer is running; the storage period timer has expired or the remaining time before expiry is less than a threshold; the amount stored data volume is larger than a threshold (e.g. max stored data volume); load/NW congestion conditions. The WTRU may transmit DP data if congestion is not determined/detected, whereby the WTRU may determine the congestion level from NW signaling (e.g. broadcast or dedicated MAC and/or DCI signaling); Determined NES state. The WTRU may transmit DP data if NW is not determined to be a network energy saving, whereby the WTRU may determine the NES state from NW signaling (e.g. broadcast or dedicated MAC or DCI signaling) or from the periodicity of broadcasted common signals/channels; WTRU power saving state. The WTRU may transmit DP data while C-DRX is not activated, during the active period of C-DRX or cell DTX, or during configured periods that occur periodically; WTRU CPU load or processing state. UE may transmit/buffer DP data only in a subset of UE states (e.g. while the UE is not overheating, available memory is greater than a threshold, or CPU consumption is less than a threshold); time of the day condition; a data collection reporting request from application layer, for instance, if the collected data is to be sent to an application server outside the operator's network; a measured channel condition being larger or lower than than a configured threshold. For example, DP data may be transmitted only if the power headroom is below a given threshold (e.g. is a positive value). DP data may be transmitted when the WTRU measures RSRP or a metric related to UL and/or DL coverage being better than a configured threshold; the PBR value and/or Bj value associated with a DP LCH or logical buffer (e.g. being larger than or lower a threshold) and/or any of the conditions for data availability/reporting above and/or herein.

In some examples, the WTRU may be configured with a temporal priority timer and more than one LCH priority and/or PBR. The configuration is per PDCP entity, per SDAP entity, per data type (ML vs sensing), per collection data type, per collection data plane LCH/RB, per logical buffer, per collection data unit, and/or per collection data unit set.

If DP data is made available to lower layers (e.g. MAC and/or PDCP), the WTRU may start a temporal priority timer associated with the data unit or data flow. Upon expiry of a temporal priority timer, the WTRU may upgrade or lower priority/PBR of a DP data flow to the next higher or lower configured non-default priority/PBR and restarts the timer, where such LCH priority and/or PBR may be used in the LCP procedure when contending for UL resources with other user plane data that is buffered. Additionally and/or alternatively, the WTRU may stop multiplexing and/or transmission of data plane data upon expiry of the timer.

In some examples, the WTRU may start a first timer associated with the data unit or data flow. If the first timer expires and certain conditions are not fulfilled (e.g., DP data was not scheduled/transmitted at that time, it was scheduled but the amount of data sent was below a certain configured level, etc. ,), WTRU may upgrade the priority/PBR of the DP data flow to a higher configured non-default priority/PBR and starts a second timer. The WTRU may be configured to apply this behavior in a step wise fashion with multiple timers and associated priority levels (e.g., increasing the priority each time the timer expires, and the required amount of data is not sent).

In some examples, the WTRU may start/stop multiplexing and/or transmission of data plane data based on one or more of the following triggering conditions. For example, the WTRU may start/stop multiplexing and/or transmission of data plane data based on indication from network. For example, the network may implicitly/explicitly indicate the WTRU to start/stop. Upon reception of the indication from the network, the WTRU may follow the network's indication. Specifically, if the network indicates the WTRU to stop multiplexing and/or transmission of data plane data, the WTRU may not select the data plane data in the LCP procedure for construction of a MAC PDU for transmission. Alternatively, if the WTRU receive an indication from the network to start the multiplexing and/or transmission, the WTRU may select data plane data in an LCP procedure. Such indication may be conveyed to the WTRU via DCI/MAC-CE and/or RRC.

The WTRU may start/stop multiplexing and/or transmission of data plane data based on the availability of data from user plane. For example, the WTRU may stop multiplexing and/or transmission of data plane data if the amount of data plane buffered (e.g., potentially associated with a certain DRBs/LCHs) is larger than a configured threshold.

The WTRU may start/stop multiplexing and/or transmission of data plane data based on Downlink channel measurement. For example, the WTRU may start multiplexing and/or transmission of data plane data if the measured Uu RSRP is larger than a configured threshold. Otherwise, if the measured Uu RSRP is smaller than a configured threshold, the WTRU may stop multiplexing and/or transmission of data plane data.

The WTRU may start/stop multiplexing and/or transmission of data plane data based on WTRU CPU load or processing state.

In some examples, for a received uplink grant, the WTRU may trigger transmission/multiplexing of the data plane data if DP data transmission condition is met, including one or more of the following conditions: reception of indication from the network to transmit; after transmission of a DP BSR; and/or one or more of the conditions listed and/or discussed herein (e.g. within the section which discussed conditional availability of data for transmission (e.g. at MAC)).

In some examples, the WTRU may prioritize the multiplexing of DP data whereby the WTRU may allocate resources to data plane data in the grant in a second round after PBR allocation round of user plane LCHs (e.g., the WTRU may exclude data plane data from the first round of resource allocation in LCP). The WTRU may serve data plane LCHs up to PBR only (e.g., strict traffic shaping compliance), for instance, in the second round after all user plane data has been allocated.

In some examples, the WTRU may be configured with an exclusion mechanism (e.g. an LCP restriction for DP data or a conditional LCP restriction) which depends on the type of other data already multiplexed/can be multiplexed in the grant. For example, the WTRU may exclude DP data if SRB data is included in the grant, UP data is included in the grant, UP data of a certain (priority, importance, reliability level, QoS class, stringent remaining time—below a threshold—) is included in the grant and is above or below a threshold. Similarly, CP and/or UP data may conditionally exclude if DP data is multiplexed in the grant.

In some examples, the WTRU may receive an indication/command from the network (e.g., in a MAC-CE or an indication by DCI) instructing it to alter the PBR, Bj, and/or the QoS class associated with a DP LCH or logical buffer or a given DP SDU or a grant applicable for DP data.

In some examples, the WTRU may be configured with: a user plane and a data plane (DP) protocol stack, in which the data plane may be used to process data collected for AI/ML and/or sensing; one or more parameters for data plane buffer management (e.g., max stored data volume and a storage period duration); and/or one or more thresholds to report the data plane buffer status (e.g., a user plane volume and/or priority, a data plane volume)

In some examples, a WTRU may store and/or generate the data plane data upon arrival of the data and/or reception of data plane generation request from the network. If the amount of stored data volume is larger than a threshold, the WTRU may flush and/or discard X bits/units of the first stored data in this FIFO buffer, where X is configured or equal to the amount of data arrival to the LCH's buffer.

In some examples, the WTRU may trigger data plane buffer status reporting based on a triggering condition is satisfied. A triggering condition may include one or more of the following: DL signaling is received from the network polling and/or requesting for a DP BSR; buffered user plane data is of priority is less than a threshold; buffered user plane data volume is less than a threshold; the data stored in the buffer is greater than a threshold; and/or buffered data plane volume is greater than a threshold.

In some examples, the WTRU may trigger transmission and/or multiplexing of the data plane data based on the transmission and/or multiplexing condition is met. Transmission and/or multiplexing conditions may include reception of indication (e.g., DCI) from the network to transmit the data plane data; and/or data plane buffer status reporting was transmitted.

In some examples, a WTRU may be configured with user plane (e.g., as in legacy) and a data plane (DP) protocol stack, in which the data plane may be used to process (e.g., sends, transmits, stores) data collected for AI/ML and/or sensing. In some examples, a WTRU may be configured with one or more parameters for data plane buffer management, where the one or more parameters may include a maximum stored data volume and a storage period timer; a temporal priority timer and more than one LCH priority and/or PBR. The configuration is per PDCP entity, per SDAP entity, per data type (ML vs sensing), per collection data type, per collection data plane LCH/RB, per logical buffer, per collection data unit, and/or per collection data unit set. Alternatively, the data volume and storage timer configuration can be for the whole data collection (e.g., it may be left up to UE to allocate the max storage among the different data collection processes/bearers).

In some examples, upon data plane data arrival, the WTRU may stores and/or may generate data plane data. If the WTRU stores and/or generates data plane data may be conditioned on reception of a generation request from the network. That is, the WTRU may not collect data or consider it available in the RAN protocol stack until a request is received from the gNB (e.g., the NW may have control on when the WTRU starts collecting, storing, reporting, and/or transmitting DP data).

In some examples, upon data plane data arrival, the WTRU may start a storage period timer, for example, one timer for a certain data collection process/bearer, separate timers for each collected data unit (e.g. the value of the timer may be dependent on a data type, LCH/RB, and/or based on data importance/QoS class), where the WTRU may start the timer based on one or more of the following condition(s): when the data collection process is initiated (e.g., by explicit signal from the network, based on reception of command from application layers, etc.); when the first data sample is logged/collected; when the first data sample is transmitted; when the last data sample is logged/collected (e.g., the last sample that will make the buffer that is available for the concerned data collection bearer/process); and/or when a certain amount of data is logged (e.g., in number of samples, in number of bits, etc.). Upon expiry of the storage period timer, the WTRU may be configured to perform one or more of the following. For example, the WTRU may discard the associated SDU (e.g., if the timer is associated with a data unit). The WTRU may discard the whole collected data associated with the storage timer (e.g., if the timer is configured per data collection process/bearer). The WTRU may discard some of the collected data to make room for new data. The WTRU may initiate the transmission of some of the collected data.

In some examples, upon data plane data arrival, the WTRU may increment the amount of stored data volume by the amount of collection data that has arrived. For example, if the amount stored data volume is larger than a threshold, the WTRU may flush/discard X bits/units of the fist stored data in this FIFO buffer, where X is configured or equal to the amount of data arrival to the LCH's buffer. That is, data buffer can be used in a circular fashion where older entries are removed to make room for newer data. In one example, only data samples/units that have their discard timer expires can be deleted. In another example, even data samples/units that have their discard timer still running may be deleted. In another example, only data samples/units that are of a certain QoS classification may be deleted. For example, only data of priority/importance less than a threshold may be deleted. The value of the stored data volume may be maintained by implementing a counter at the WTRU, and may be dependent on a data type, LCH/RB, and/or based on data importance/QoS class (e.g. where the WTRU maintains a counter per data type, per data importance, per QoS class, or per LCH/RB etc.). The WTRU may be configured to pause a given data collection process when the buffer associated with that data collection is full and it was not able to send the collected data to make room for new data (e.g., instead of discarding it), possibly conditioned on data type, DP LCH/RB, or QoS classification. The WTRU may be configured with a prohibit timer for this deletion. For example, the WTRU starts this timer upon the buffer becoming full, pauses the data collection process, and upon the timer expiry, resumes the data collection process, and will start discarding of older data to make room for the new data. If the data volume decreases even before the timer expiry (e.g., WTRU was able to send some of the DP data), the WTRU may stop the timer and resume the data collection process. The WTRU may remove data from one buffer associated with a given data type, LCH, or QoS class to make room for data of another type/LCH/QoS class that is more important, e.g. if the WTRU's DP buffer size is limited (e.g. the memory allocated for data collection across all LCHs/data types/QoS classes).

In some examples, upon data plane data arrival, the WTRU may trigger reporting of a data plane buffer status report if one or more of the following conditions are met: buffered user plane data is of priority is less than a threshold; buffered user plane data volume is less than a threshold; DL signaling is received from the network polling/requesting for a DP BSR; the storage period timer has expired or the remaining time before expiry is less than a threshold; the amount stored data volume is larger than a threshold (e.g. max stored data volume); load/NW congestion conditions; determined NES state; the WTRU power saving state; the WTRU CPU load or processing state; time of the day condition; a data collection reporting request from application layer (e.g., if the collected data is to be sent to an application server outside the operator's network); and/or a measured channel condition being larger or lower than than a configured threshold.

In some examples, upon data plane data arrival, the WTRU may make data plane data available for transmission at lower layers (e.g. PDCP or MAC) if one or more of the following conditions are met: one or more of the conditions above for triggering reporting of DP BSR.

In some examples, upon data plane data arrival, if DP data is made available to lower layers (e.g. MAC or PDC), the WTRU may start a temporal priority timer associated with the data unit or data flow. Upon expiry of a temporal priority timer, the WTRU may upgrade and/or lower the priority/PBR of a DP data flow to the next higher and/or lower configured non-default priority/PBR and may restart the timer, where such LCH priority and/or PBR may be used in the LCP procedure when contending for UL resources with other user plane data that is buffered. Additionally and/or alternatively, the WTRU may start a first timer associated with the data unit or data flow. If the first timer expires and certain conditions are not fulfilled (e.g., DP data was not scheduled/transmitted at that time, it was scheduled but the amount of data sent was below a certain configured level, etc.), the WTRU may upgrade priority/PBR of the DP data flow to a higher configured non-default priority/PBR and starts a second timer. The WTRU may be configured to apply this behavior in a step wise fashion with multiple timers and associated priority levels (e.g., increasing the priority each time the timer expires, and the required amount of data is not sent).

In some examples, for a received uplink grant, the WTRU may triggers transmission and/or multiplexing of the data plane data if DP data transmission condition is met, including: reception of indication from the network to transmit and/or after transmission of a DP BSR. For a received uplink grant, the WTRU may prioritize the multiplexing of DP data per the following. For example, the WTRU may allocate resources to data plane data in the grant in a second round after PBR allocation round of user plane LCHs (e.g., the WTRU may exclude data plane data from the first round of resource allocation in LCP). For example, the WTRU may serve data plane LCHs up to PBR only (e.g., strict traffic shaping compliance), for instance, in the second round after all user plane data has been allocated.

In some examples, the WTRU may receive an indication and/or command from the network (e.g., in a MAC-CE and/or an indication by DCI) instructing it to consider the DP data/LCH to the same level of consideration/priority as the UP (e.g., for a given time duration, until a certain amount of data is sent, where the amount could be in actual number of bits or in percentage of the collected data, etc.). That is, during this time duration, UP and DP traffic are handled the same way by the MAC (e.g., BSR/SR triggering, rate/scheduling control, etc.), and may also be reported jointly in the same SR/BSR report. In some examples, the indication/command may be instructing the WTRU to prioritize the DP over UP for a given time duration.

DP and UP intra-WTRU prioritization may be implemented. In some examples, the WTRU may be configured with a user plane protocol stack and a data plane protocol stack. The WTRU may process data collected for AI/ML and/or sensing/positioning using the data plane protocol stack. For a data plane LCHs, the WTRU may be configured with more than one LCH priority and/or PBR, where the lowest, highest, and/or a default configured priority/PBR is set for the LCH upon starting a temporal LCH priority timer. The WTRU may process user data and RRC data using the user plane protocol stack. Upon user plane data arrival, a user plane BSR may be triggered. Upon data plane data arrival, the WTRU may trigger a data plane BSR, may start a data relevance discard timer, and/or may start a temporal LCH priority timer. If the WTRU doesn't have a grant, the WTRU may send a scheduling request. The WTRU may report BSRs to the network, with user plane BSR MAC-CE having higher multiplexing priority than data plane BSR.

In some examples, for a received uplink grant, the WTRU may prioritize the multiplexing of data and CEs per the following. For example, the WTRU may prioritize user plane data and control elements (e.g. per legacy rules), possibly up to shaping/bucket levels. The WTRU may prioritize data plane data and control elements per data plane prioritization rules, possibly up to shaping/bucket levels. For example, there may be a list of priorities amongst data plane data and control elements (e.g. data plane CEs first, data plane data second, etc.)

In some examples, the WTRU may run LCP jointly for both user and data plan data. For example, the WTRU may serve LCH data up to PBR only for user plane LCHs. The WTRU may allocate resources to data plane LCHs in the grant in a second round after PBR allocation round of user plane LCHs, (e.g. the WTRU may exclude data plane LCHs from the first round of resource allocation in LCP). Additionally and/or alternatively, the WTRU may serve data plane LCHs up to PBR only (e.g., and skip them in the second round of resource allocation). Upon expiry of the “temporal LCH priority timer”, the WTRU may assign the next higher and/or lower priority and/or PBR configured for the data plane LCH (e.g., one step) and the WTRU may restart the timer.

Upon expiry of the data relevance discard timer, the WTRU may discard the associated data plane SDU. Upon collecting data of the same type that replaced already buffered and/or collected data, the WTRU may discard the already buffered data plane SDU that has been replaced.

1. A wireless transmit/receive unit (WTRU) comprising:
a processor configured to:
receive configuration information from a network, wherein the configuration information indicates that the WTRU is configured to process data of a first data type and data of a second data type, wherein the data of the first data type comprises user plane data, and wherein the configuration information further comprises one or more parameters for buffer management for the second data type and a threshold to send a buffer status report associated with the data of the second data type;
store the data of the first data type in a first buffer;
store the data of the second data type in a second buffer based on the one or more parameters for buffer management for the second data type; and
based on a comparison between the threshold and the data of the second data type stored in the second buffer or the data of the first data type stored in the first buffer, send the buffer status report and send at least a portion of the data of the second data type.

2. The WTRU of claim 1, wherein the processor is configured to:
send the buffer status report based on the data of the second data type stored in the second buffer being greater than the threshold.

3. The WTRU of claim 1, wherein the processor is configured to:
send the buffer status report based on the data of the first data type stored in the first buffer being less than the threshold.

4. The WTRU of claim 1, wherein the processor is configured to:
send the buffer status report based on a priority of the data of the first data type stored in the first buffer being less than the threshold.

5. The WTRU of claim 1, wherein the processor is configured to:
send the buffer status report based on reception of a request from the network.

6. The WTRU of claim 1, wherein the data of the second data type comprises artificial intelligence or machine learning (AI/ML) data or data relating to a sensing operation.

7. The WTRU of claim 1, wherein the processor is configured to:
receive a request from the network to generate the data of the second data type; and
generate the data of the second data type in response to the request.

8. The WTRU of claim 1, wherein the processor is configured to:
receive the data of the second data type; and
store the data of the second data type in response to the reception of the data of the second data type.

9. The WTRU of claim 1, wherein the processor is configured to:
start a timer associated with the data of the second data type; and
upon an expiration of the timer, perform one or more of the following:
discard a service data unit (SDU) associated with the data of the second data type;
discard at least a portion of the data of the second data type; or
send at least at portion of the data of the second data type.

10. The WTRU of claim 1, wherein the processor is configured to:
increment a stored data volume associated with the data of the second data type based on an amount of the data.

11. The WTRU of claim 1, wherein the processor is configured to receive an indication from the network via downlink control information (DCI) to transmit at least a portion of the data of the second data type.

12. A method performed by a wireless transmit/receive unit (WTRU), the method comprising:
receiving configuration information from a network, wherein the configuration information indicates that the WTRU is configured to process data of a first data type and data of a second data type, wherein the data of the first data type comprises user plane data, and wherein the configuration information further comprises one or more parameters for buffer management for the second data type and a threshold to send a buffer status report associated with the data of the second data type;
storing the data of the first data type in a first buffer;
storing the data of the second data type in a second buffer based on the one or more parameters for buffer management for the second data type; and
based on a comparison between the threshold and the data of the second data type stored in the second buffer or the data of the first data type stored in the first buffer, sending the buffer status report and sending at least a portion of the data of the second data type.

13. The method of claim 12, wherein the method further comprises:
sending the buffer status report based on the data of the second data type stored in the second buffer being greater than the threshold.

14. The method of claim 12, wherein the method further comprises:
sending the buffer status report based on the data of the first data type stored in the first buffer being less than the threshold.

15. The method of claim 12, wherein the method further comprises:
sending the buffer status report based on a priority of the data of the first data type stored in the first buffer being less than the threshold.

16. The method of claim 12, wherein the method further comprises:
sending the buffer status report based on reception of a request from the network.

17. The method of claim 12, wherein the data of the second data type comprises artificial intelligence or machine learning (AI/ML) data or data relating to a sensing operation.

18. The method of claim 12, wherein the method further comprises:
receiving a request from the network to generate the data of the second data type; and
generating the data of the second data type in response to the request.

19. The method of claim 12, wherein the method further comprises:
receiving the data of the second data type; and
storing the data of the second data type in response to the reception of the data of the second data type.

20. A wireless transmit/receive unit (WTRU) comprising:
a processor configured to:
receive configuration information from a network, wherein the configuration information indicates that the WTRU is configured to process data of a first data type and data of a second data type, wherein the data of the first data type comprises user plane data, wherein the data of the second data type comprises artificial intelligence or machine learning (AI/ML) data or data relating to a sensing operation, and wherein the configuration information further comprises one or more parameters for buffer management for the second data type and an indication of a trigger to send a buffer status report associated with the data of the second data type;
store the data of the first data type in a first buffer;
store the data of the second data type in a second buffer based on the one or more parameters for buffer management for the second data type;
start a timer associated with storage of the data of the second data type; and
based on the trigger, send the buffer status report and send at least a portion of the data of the second data type.
